(19) United States
(12) Patent Application Publication
(10) Pub. No.: US 2026/0302181 A1
(43) Pub. Date: Oct. 1, 2026

(54) BLENDED CATHODE ACTIVE MATERIAL INCLUDING IRON PHOSPHATE BASED AND NICKEL OXIDE BASED MATERIALS, AND METHODS THEREOF

(71) Applicant: Tesla, Inc., Austin, TX (US)

(72) Inventors: Jeffery R. Dahn, Halifax (CA); Chongyin Yang, Halifax (CA); Meng Yue, Halifax (CA); Connor P. Aiken, Halifax (CA)

(21) Appl. No.: 19/478,761

(22) PCT Filed: Apr. 30, 2024
(86) PCT No.: PCT/US2024/027102

§ 371 Date: Oct. 24, 2025

Related U.S. Application Data
(60) Provisional application No. 63/499,655, filed on May 2, 2023.

(51) Int. Cl. H01M 4/36; C01G 53/50; C01G 53/506; H01M 4/525; H01M 4/58

(52) U.S. Cl. CPC H01M 4/364; C01G 53/50; C01G 53/506; H01M 4/525; H01M 4/5825; C01P 2002/72; C01P 2004/03; C01P 2004/80; C01P 2006/40

(57) ABSTRACT

Blended cathode active materials including an iron phosphate based active material and a nickel oxide based active material, and methods of manufacture, are described. The blended cathode active materials enable energy storage devices with improved performances, including but not limited to improved capacity retention and cycling lifetime.

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6. This application claims the benefit of U.S. Provisional Application No. 63/499,655, entitled BLENDED CATHODE ACTIVE MATERIAL INCLUDING IRON PHOSPHATE BASED AND NICKEL OXIDE BASED MATERIALS, AND METHODS THEREOF, filed on May 2, 2023, which is incorporated by reference herein in its entirety for all purposes.

### BACKGROUND

### Field

The present disclosure relates generally to energy storage devices, and specifically to cathode active materials for lithium-ion batteries and processes for forming the same.

### Description of the Related Art

Energy storage devices are widely used to provide power to electronic, electromechanical, electrochemical, and other useful devices. Such cells include primary chemical cells, secondary (rechargeable) cells, fuel cells, and various species of capacitors, including ultracapacitors. Increasing the operating voltage and temperature limits of electrochemical energy storage devices can result in increased energy density, increased power capability, and broadening the range of real-world use cases.

Some cathode electrodes in lithium-ion batteries are fabricated from first row transition metal oxides. Examples of such cathode active materials include lithium cobalt oxide (LCO), lithium nickel manganese cobalt oxide (NMC) and lithium manganese oxide (LMO). Some other cathode electrodes in lithium-ion batteries include transition metal phosphate, such as lithium iron phosphate (LFP). However, the performance of cathode active materials used in lithium-ion batteries can be responsible for inferior and undesirable battery performance, including the loss of charge storage capacity during repeated charge/discharge cycles.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a blended cathode active material is described. The blended cathode active material comprises: an iron phosphate based active material; and a nickel oxide based active material comprising at least one lithium nickel manganese cobalt oxide or lithium nickel cobalt aluminum oxide. In some examples, the iron phosphate based active material is selected from the group consisting of lithium iron phosphate (LFP), lithium manganese iron phosphate (LMFP), and combinations thereof. In some examples, the nickel oxide based active material is selected from the group consisting of lithium nickel manganese cobalt oxide (NMC), lithium nickel cobalt aluminum oxide (NCA), and combinations thereof. In some examples, the NMC is selected from the group consisting of NMC550, NMC640, NMC631, NMC730, NMC75:25:0, NMC532, NMC111, NMC811, NMC622, NMC Ni83, NMC Ni91, and combinations thereof.

In some examples, the blended cathode active material comprises the iron phosphate based active material at a concentration of about 90-99 wt. %. In some examples, the blended cathode active material comprises the nickel oxide based active material at a concentration of about 0.1-15 wt. %. In some examples, the blended cathode active material comprises the nickel oxide based active material at a concentration of about 0.1-3 wt. %. In some examples, the nickel oxide based active material comprises a specific surface area of at least about 4 m²/g. In some examples, the nickel oxide based active material comprises a lithium-containing impurity of less than about 3 wt. %. In some examples, the lithium containing impurity is selected from the group consisting of LiOH, Li₂CO₃, and combinations thereof. In some examples, the nickel oxide based active material comprises LiOH in an amount of less than about 0.5 wt. %. In some examples, the nickel oxide based active material comprises Li₂CO₃ in an amount of less than about 1 wt. %.

In another aspect, an energy storage device is described. The energy storage device comprises: a cathode electrode comprising a blended cathode active material; a separator; an anode electrode; an electrolyte; and a housing, wherein the cathode electrode, the separator, and the anode electrode are positioned within the housing. In some embodiments, the anode electrode comprises a graphite active material.

In another aspect, a process of forming a blended cathode active material is described. The process comprises: combining an iron phosphate based active material with a nickel oxide based active material to form a blended cathode active material mixture, wherein the nickel oxide based active material comprises at least one of a lithium nickel manganese cobalt oxide and a lithium nickel cobalt aluminum oxide.

In some examples, the process further comprises surface area processing the nickel oxide based active material prior to the combining. In some examples, surface area processing the nickel oxide based active material comprises milling. In some examples, surface area processing the nickel oxide based active material is performed in an atmosphere absent of water and CO₂. In some examples, surface area processing the nickel oxide based active material is performed in ambient air. In some examples, the process further comprises heating the nickel oxide based active material prior to combining the iron phosphate based active material and the nickel oxide based active material. In some examples, heating is performed at a temperature between 650° C. and 800° C.

In another aspect, a method of forming a blended cathode active material is described. The method comprises: surface area processing a nickel oxide based active material to form a processed nickel oxide based active material; heating the processed nickel oxide based active material at a temperature between 650° C. and 800° C. to form a treated nickel oxide based active material; and combining an iron phosphate based active material and the treated nickel oxide based active material to form a blended cathode active material mixture. In some examples, the nickel oxide based active material comprises at least one of a lithium nickel manganese cobalt oxide and a lithium nickel cobalt aluminum oxide. In some examples, a specific surface area of the treated nickel oxide based active material is larger than a specific surface area of the nickel oxide based active material. In some examples, the blended cathode active material mixture comprises the treated nickel oxide based active material in an amount of about 0.1-3 wt. %.

### BRIEF DESCRIPTION OF THE DRAWINGS

FIG. 1 illustrates a process for forming a blended cathode active material according to some embodiments.

FIG. 2 illustrates a process for processing a nickel oxide based active material according to some embodiments.

FIG. 3A shows an SEM image and XRD spectrum of unprocessed NMC powders according to some embodiments.

FIG. 3B shows an SEM image and XRD spectrum of processed NMC powders according to some embodiments.

FIG. 3C shows an SEM image of processed NMC powders according to some embodiments.

FIG. 4A shows a bar graph of the amount of LiOH and Li₂CO₃ in the unprocessed and treated NMC powders formed according to some embodiments.

FIG. 4B shows a graph of the specific surface area of unprocessed, processed and treated NMC powders formed according to some embodiments.

FIG. 5A is a plot showing the first charge/discharge voltage-capacity curves for a cell containing a blended cathode active material including LFP and NMC640 according to some embodiments, relative to a baseline cell.

FIG. 5B is a plot showing the first charge/discharge voltage-capacity curves for a cell containing a blended cathode active material including LFP and NMC Ni83 according to some embodiments, relative to a baseline cell.

FIG. 5C is a plot showing voltage vs. normalized charge capacity for cells containing a blended cathode active material including LFP and NMC640 according to some embodiments, relative to baseline cells.

FIG. 5D is a plot showing the first charge/discharge voltage-capacity curves for cells containing a blended cathode active material including LMFP and NMC640 or NMC Ni83 according to some embodiments, relative to a baseline cell.

FIG. 6A is a plot showing discharge capacity as a function of time for cells comprising various cathode active materials at 40° C. cycling, according to some embodiments.

FIG. 6B is a plot showing normalized discharge capacity as a function of time for cells comprising various cathode active materials at 40° C. cycling, according to some embodiments.

FIG. 6C is a plot showing internal resistance (via normalized delta V (dV)) as a function of time for cells comprising various cathode active materials at 40° C. cycling, according to some embodiments.

FIG. 7A is a plot showing real discharge capacity as a function of time for cells comprising various cathode active materials at 55° C. cycling, according to some embodiments.

FIG. 7B is a plot showing normalized discharge capacity as a function of time for cells comprising various cathode active materials at 55° C. cycling, according to some embodiments.

FIG. 7C is a plot showing internal resistance (via normalized delta V (dV)) as a function of time for cells comprising various cathode active materials at 55° C. cycling, according to some embodiments.

FIG. 8A is a plot showing real discharge capacity as a function of time for cells comprising various cathode active materials at 70° C. cycling, according to some embodiments.

FIG. 8B is a plot showing normalized discharge capacity as a function of time for cells comprising various cathode active materials at 70° C. cycling, according to some embodiments.

FIG. 8C is a plot showing internal resistance (via normalized delta V (dV)) as a function of time for cells comprising various cathode active materials at 70° C. cycling, according to some embodiments.

FIG. 9 are plots showing normalized discharge capacity as a function of time for cells comprising various cathode active materials at different electrochemical charging ranges, according to some embodiments.

FIG. 10A is a plot showing discharge capacity as a function of time for pouch cells comprising various cathode active materials at 70° C. cycling, according to some embodiments.

FIG. 10B is a plot showing normalized discharge capacity as a function of time for pouch cells comprising various cathode active materials at 70° C. cycling, according to some embodiments.

FIG. 10C is a plot showing internal resistance (via normalized delta V (dV)) as a function of time for pouch cells comprising various cathode active materials at 70° C. cycling, according to some embodiments.

FIG. 11A is a bar chart showing the areal loading of iron deposited on anode electrodes for cells comprising various cathode active materials after 7,000 hours of cycling at 40° C., according to some embodiments.

FIG. 11B is a bar chart showing the areal loading of iron deposited on anode electrodes for cells comprising various cathode active materials after 3,400 hours of cycling at 55° C., according to some embodiments.

FIG. 11C is a bar chart showing the areal loading of iron deposited on anode electrodes for cells comprising various cathode active materials after 4,400 hours of cycling at 70° C., according to some embodiments.

FIG. 11D is a plot showing the areal loading of iron deposited on anode electrodes for cells comprising various cathode active materials after being held at different temperatures as a function of normalized discharge capacity loss, according to some embodiments.

FIG. 12A are bar charts showing the area specific charge transfer resistance for cells comprising various cathode active material according to some embodiments, relative to a baseline cell, after being stored at 60° C.

FIG. 12B are bar charts showing the irreversible and reversible capacity loss for cells comprising various cathode active material according to some embodiments, relative to a baseline cell, after being stored at 60° C. for 500 hours.

FIG. 12C are bar charts showing the irreversible and reversible capacity loss for cells comprising various cathode active material according to some embodiments, relative to a baseline cell, after being stored at 60° C. for 1,000 hours.

FIG. 13A is a plot showing real discharge capacity as a function of cycles of the LFP/NMC622 half cells according to some embodiments.

FIG. 13B is a plot showing normalized discharge capacity as a function of cycles of the LFP/NMC622 half cells according to some embodiments.

FIG. 14A shows a voltage v. time curve at C/20 of the total capacity according to some embodiments.

FIG. 14B is an enlarged figure showing the voltage curve in the circled area in FIG. 14A.

FIG. 15A is a plot showing real discharge capacity as a function of cycles of the LFP/NMC622 and LFP single layer pouch cells according to some embodiments.

FIG. 15B shows the normalized discharge capacities as a function of cycles of the LFP/NMC622 and LFP single layer pouch cells according to some embodiments.

FIG. 15C shows internal resistance (via normalized delta V (dV)) vs. cycling time of the LFP/NMC622 and LFP single layer pouch cells according to some embodiments.

### DETAILED DESCRIPTION

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of embodiments.

Provided herein are various embodiments of blended cathode active materials with improved energy density and capacity retention, and methods for preparing the blended cathode active material. Such blended cathode active materials may allow for improved energy storage device performances, such as electrode capacities and improved cell cycling, while minimizing the use of costly elements (e.g., nickel, cobalt).

In some embodiments, blended cathode active materials may include an iron phosphate based active material and a nickel oxide based active material. In some embodiments, the iron phosphate based active material comprises lithium iron phosphate (i.e., LiFePO₄ or “LFP”), lithium manganese iron phosphate (e.g., LiMn_{0.6}Fe_{0.4}PO₄ or “LMFP”), and combinations thereof. In some embodiments, the iron phosphate based active material includes LFP. In some embodiments, the iron phosphate based active material includes LMFP. In some embodiments, the iron phosphate based active material includes LFP and LMFP.

In some embodiments, the blended cathode active material comprises the iron phosphate based active material at a concentration of, of about, of at least, or at least about, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 98.5 wt. %, 99 wt. %, 99.5 wt. %, 99.8 wt. % or 99.9 wt. %, or any range of values therebetween. For example, in some embodiments, the amount of iron phosphate based active material in the blended cathode active material is or is about in any one of the following ranges: 85-99.9 wt. %, 90-99.9 wt. %, 85-95 wt. %, 95-99.9 wt. %, 98-99.9 wt. %, or 85-99 wt. %.

In some embodiments, the nickel oxide based active material comprises lithium nickel manganese cobalt oxide (i.e., LiNiₓMn_{y}Co_{1-x-y}O₂ or “NMC”), lithium nickel cobalt aluminum oxide (i.e., LiNiₓCo_{y}Al_{z}O₂ or “NCA”), and combinations thereof. In some embodiments, a nickel oxide based active material includes lithium NMC. In some embodiments, a nickel oxide based active material includes NCA. In some embodiments, a nickel oxide based active material includes NMC and NCA. In some embodiments, the NMC is selected from the group consisting of NMC550, NMC640, NMC631, NMC730, NMC75:25:0, NMC532, NMC111, NMC811, NMC622, NMC Ni83, NMC Ni91, and combinations thereof. In some embodiments, the NMC incudes NMC550. In some embodiments, the NMC incudes NMC640. In some embodiments, the NMC incudes NMC631. In some embodiments, the NMC incudes NMC730. In some embodiments, the NMC incudes NMC75:25:0. In some embodiments, the NMC incudes NMC532. In some embodiments, the NMC incudes NMC111. In some embodiments, the NMC incudes NMC811. In some embodiments, the NMC incudes NMC622. In some embodiments, the NMC incudes NMC Ni83. In some embodiments, the NMC incudes NMC Ni91. In some embodiments, the NMC incudes NMC640 and NMC Ni83.

In some embodiments, the blended cathode active material comprises the nickel oxide based active material at a concentration of, of about, of at least, or at least about, 0.1 wt. %, 0.2 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. % or 15 wt. %, or any range of values therebetween. For example, in some embodiments, the amount of nickel oxide based active material in the blended cathode active material is or is about in any one of the following ranges: 0.1-15 wt. %, 1-15 wt. %, 0.1-10 wt. %, 1-10 wt. %, 5-10 wt. %, 1-9 wt. %, 10-15 wt. %, 9-11 wt. %, 5-9 wt. %, 1-3 wt. %, 0.1-3 wt. %, 1-2.5 wt. %, 0.1-2.5 wt. %, or 0.1-3 wt. %.

In some embodiments, the nickel oxide based active material comprises a specific surface area of, of about, of at least, or at least about, 1 m²/g, 2 m²/g, 2.5 m²/g, 3 m²/g, 3.5 m²/g, 3.75 m²/g, 4 m²/g, 4.25 m²/g, 4.5 m²/g, 4.75 m²/g, 5 m²/g, 5.25 m²/g, 5.5 m²/g. 5.75 m²/g, 6 m²/g, 6.25 m²/g, 6.5 m²/g, 7 m²/g, 8 m²/g, 9 m²/g, 10 m²/g, 11 m²/g, 12 m²/g, 13 m²/g, 14 m²/g, 15 m²/g, or any ranges of values therebetween. In some embodiments, the specific surface area is measured by a Brunauer-Emmett-Teller (BET) method.

In some embodiments, the nickel oxide based active material comprises a lithium-containing impurity. In some embodiments, the lithium-containing impurity comprises LiOH, Li₂CO₃, or combinations thereof. In some embodiments, the nickel oxide based active material comprises a lithium-containing impurity in an amount of, of about, of at most, or at most about, 0.1 wt. %, 0.5 wt. %, 1.0 wt. %, 1.5 wt. %, 2 wt. %, 3 wt. %, 4 wt. %, 5 wt. %, or any range of values therebetween. In some embodiments, the nickel oxide based active material comprises LiOH in an amount of, of about, of at most, or at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 2 wt. %, 3 wt. %, or any range of values therebetween. In some embodiments, the nickel oxide based active material comprises a Li₂CO₃ in an amount of, of about, of at most, or at most about, 0.2 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.4 wt. %, 1.5 wt. %, 2 wt. %, or any range of values therebetween. In some embodiments, the concentration of impurities, such as LiOH or Li₂CO₃, is determined by a titration test.

In some embodiments, the blended cathode active material includes additional active materials, such as lithium manganese oxide (“LMO”), lithium nickel manganese oxide (“LNMO”), lithium cobalt oxide (“LCO”), lithium titanate (“LTO”), or combinations thereof. In some embodiments, the blended cathode active material includes at least two of LFP, LMFP, NMC, NCA, LMO, LNMO, LCO, LTO, and combinations thereof.

### Blended Cathode Active Material Formation Process

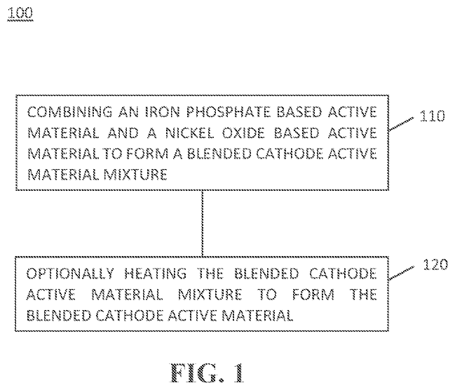

The blended cathode active material may be formed through a variety of processes. FIG. 1 illustrates an exemplary process 100 for fabricating the blended cathode active material. The process 100 includes a first step 110 of combining an iron phosphate based active material and a nickel oxide based active material to form a blended cathode active material mixture. In some embodiments, the combining is performed at room temperature. In some embodiments, the combining is performed at ambient temperature to form the blended cathode active material mixture. In some embodiments, combining the iron phosphate based active material and the nickel oxide based active material comprises mixing the iron phosphate based active material with the nickel oxide based active material. In some embodiments, the mixing comprises a step selected from milling, blending, and combinations thereof. In some embodiments, the iron phosphate based active material and the nickel oxide based active material are mixed in a ratio intended in the electrode film. In certain embodiments, the blended cathode active material mixture is combined (e.g., mixed) with a lithium source to form an active material mixture.

With continued reference to FIG. 1, in some embodiments, the fabrication process 100 includes an optional step 120 of heating the blended cathode active material mixture to form the blended cathode active material. In some embodiments, the blended cathode active material is utilized in an electrode film. In some embodiments, the blended cathode active material mixture is heated at a temperature of, of about, of at least, of at least about, of at most, of at most about, 650° C., 660° C., 670° C., 680° C., 690° C., 700° C., 710° C., 720° C., 730° C., 740° C., 750° C., 760° C., 770° C., 780° C., 790° C., 800° C., or any ranges of values therebetween. In some embodiments, the blended cathode active material mixture is not heated before being utilized in an electrode film. In some embodiments, the process of forming a blended cathode active material includes mixing an iron phosphate based active material with a nickel oxide based active material to form a blended cathode active material.

In some embodiments, the process 100 further includes increasing the specific surface area of the blended cathode active material mixture. In some embodiments, increasing the specific surface area of the blended cathode active material mixture comprises a step selected from crushing, milling, and combinations thereof. In some embodiments, the process 100 further includes treating the blended cathode active material mixture. In some embodiments, treating comprises a step selected from sieving, washing, filtering, drying, coating, and combinations thereof.

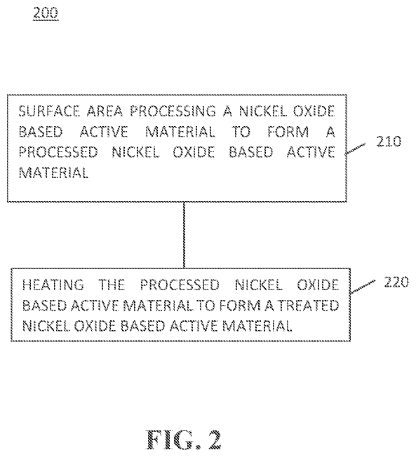

In some embodiments, a nickel oxide based active material is processed before being combined with an iron phosphate based active material. FIG. 2 illustrates an exemplary process 200 for processing the nickel oxide based active material before being combined with the iron phosphate based active material. The process 200 comprises a step 210 of surface area processing an unprocessed nickel oxide based active material to form a processed nickel oxide based active material. In some embodiments, the surface area processing increases the specific surface area of the nickel oxide based active material. In some embodiments, the surface area processing reduces the particle size, modifies and/or texturizes the surface of the particles, and/or disintegrates the particle aggregates. In some embodiments, the surface area processing of the nickel oxide based active material comprises crushing, milling, grinding and combinations thereof. In some embodiments, the surface area processing of the nickel oxide based active material comprises surface roughening. In some embodiments, the surface area processing of the nickel oxide based active material comprises destructuring the nickel oxide based active material. In some embodiments, the milling is selected from the group consisting of a planetary ball-mill, a Spex mill, a high shear high energy mill, an attritor mill, and a vibratory mill, or combinations thereof. In some embodiments, surface area processing of the nickel oxide based active material comprises ball milling.

In some embodiments, the surface area processing of the nickel oxide based active material is performed for a period of, of about, of at least, of at least about, 10 hours, 20 hours, 30 hours, 40 hours, 50 hours, 60 hours, 70 hours, 80 hours, 90 hours, 100 hours, 110 hours, 120 hours, 130 hours, 140 hours, 150 hours, 160 hours, 170 hours, 180 hours, 190 hours, 200 hours, 250 hours, 300 hours, or any range of values therebetween. In some embodiments, the processed nickel oxide based active material comprises a specific surface area of, of about, of at least, or at least about, 10 m²/g, 11 m²/g, 12 m²/g, 13 m²/g, 14 m²/g, 15 m²/g, 16 m²/g, 17 m²/g, 18 m²/g, 19 m²/g, 20 m²/g, 21 m²/g, 22 m²/g, 23 m²/g, 24 m²/g, 25 m²/g, 25 m²/g, 26 m²/g, 27 m²/g, 28 m²/g, 29 m²/g, 30 m²/g, 35 m²/g, 40 m²/g, 45 m²/g, 50 m²/g, or any ranges of values therebetween. In some embodiments, the specific surface area is measured by a Brunauer-Emmett-Teller (BET) method.

With continued reference to FIG. 2, the process 200 may comprise a step 220 of heating the processed nickel oxide based active material to form a treated nickel oxide based active material. In some embodiments, the treated nickel oxide based active material is combined with an iron phosphate based active material to form a blended cathode active material mixture, such as in the process 100. In some embodiments, the heating is performed at a temperature of, of about, of at least, of at least about, of at most, of at most about, 650° C., 660° C., 670° C., 680° C., 690° C., 700° C., 710° C., 720° C., 730° C., 740° C., 750° C., 760° C., 770° C., 780° C., 790° C., 800° C., or any ranges of values therebetween. For example, the heating may be performed at a temperature between about 650° C. to about 800° C., 660° C. to about 800° C., 670° C. to about 800° C., 670° C. to about 780° C., 670° C. to about 750° C., 690° C. to about 750° C., or any ranges of values therebetween. In some embodiments, the heating is performed for a period of, of about, of at least, of at least about, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, or any range of values therebetween. In some embodiments, the heating is performed in the presence of oxygen. In some embodiments, the heating is performed in the atmosphere of oxygen. In some embodiments, the treated nickel oxide based material comprises a specific surface area larger than the specific surface area of the unprocessed nickel oxide based active material. In some embodiments, heating for a certain amount of time and temperature may reduce the amount of impurities in the nickel oxide based active material while the treated nickel oxide based material still retains a specific surface area larger than the unprocessed nickel oxide based active material.

In some embodiments, alternative to or in addition to heating, the processed nickel oxide based active material is washed with an aqueous solution to form the treated nickel oxide based active material. In some embodiments, the aqueous solution comprises an initial pH between about 9 and about 11.

In some embodiments, an unprocessed nickel oxide based active material is treated to form the treated nickel oxide based active material without being heated. In some embodiments, the unprocessed nickel oxide based active material is treated to form the treated nickel oxide based active material in a one-step process. In some embodiments, the one-step process comprises surface area processing of the nickel oxide based active material in an atmosphere without or substantially without air, for example, in a glove box. In some embodiments, the one-step process comprises surface area processing of the unprocessed nickel oxide based active material in an atmosphere without or substantially without CO₂ and water.

In some embodiments, a nickel oxide based active material is synthesized to achieve the similar properties of the treated nickel oxide based active material. In some embodiments, the synthesis comprises spray pyrolysis of a solution comprises a nickel, cobalt, manganese and lithium nitrate solutions. In some embodiments, the synthesis comprises co-precipitation synthesis of NMC (OH) 2 precursor followed by heating the co-precipitated product with a lithium source. In some embodiments, the synthesized nickel oxide based active material comprises a D50 particle size of, of about, of at most, or at most about, of at least, of at least about, 5 μm, 4 μm, 3 μm, 2 μm, 1 μm, or any range of values there between, such as about 1-2 μm.

In some embodiments, the treated nickel oxide based active material comprises a specific surface area of, of about, of at least, or at least about, 1 m²/g, 2 m²/g, 2.5 m²/g, 3 m²/g, 3.5 m²/g, 3.75 m²/g, 4 m²/g, 4.25 m²/g, 4.5 m²/g, 4.75 m²/g. 5 m²/g, 5.25 m²/g, 5.5 m²/g, 5.75 m²/g, 6 m²/g, 6.25 m²/g, 6.5 m²/g, 7 m²/g, 8 m²/g, 9 m²/g, 10 m²/g, 15 m²/g, or any ranges of values therebetween. In some embodiments, the specific surface area is measured by a Brunauer-Emmett-Teller (BET) method. In some embodiments, the specific surface area of the treated nickel oxide based active material is or is about, is at least, is at least about, 1.5, 2, 3, 4, 5, 10, 15, 20, 25, 30, 35, 40, 45, 50 times of the unprocessed nickel oxide based active material, or any ranges of values therebetween.

In some embodiments, the treated nickel oxide based active material comprises a reduced amount of lithium-containing impurity comparing to the processed nickel oxide based active material. In some embodiments, the lithium-containing impurity comprises LiOH, Li₂CO₃, or combinations thereof. In some embodiments, the treated nickel oxide based active material comprises a lithium-containing impurity in an amount of, of about, of at most, or at most about, 0.1 wt. %, 0.5 wt. %, 1.0 wt. %, 1.5 wt. %, 2 wt. %, 3 wt. %, 4 wt. %, 5 wt. %, or any range of values therebetween. In some embodiments, the treated nickel oxide based active material comprises LiOH in an amount of, of about, of at most, or at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 2 wt. %, 3 wt. %, or any range of values therebetween. In some embodiments, the treated nickel oxide based active material comprises a Li₂CO₃ in an amount of, of about, of at most, or at most about, 0.2 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.4 wt. %, 1.5 wt. %, 2 wt. %, or any range of values therebetween. In some embodiments, the amount of lithium-containing impurity in the treated nickel oxide based active material is, is about, is less than, is less than about 5, 4, 3, 2, 1, 0.5 times of the amount of lithium-containing impurity in the unprocessed nickel oxide based active material, or any ranges of values therebetween.

In some embodiments, the treated nickel oxide based active material has a larger specific surface area than the unprocessed nickel oxide based active material, while the impurity amount in the treated nickel oxide based active material is similar or less than the impurity in the unprocessed nickel oxide based active material, such that the use of treated nickel oxide based active material may greatly reduce the amount of nickel oxide based active material needed to form the blended cathode active material for an electrode of an energy storage device, while the energy storage device can still achieve improved performance.

### Electrode Film

The blended cathode active material may be used in the preparation of an electrode film and/or electrode for an energy storage device. In some embodiments, an electrode film (e.g., cathode electrode film) comprises the blended cathode active material. In some embodiments, an electrode comprises a current collector and an electrode film. In some embodiments, the electrode is a cathode electrode. In some embodiments, the electrode film and/or electrode includes the blended cathode active material. In some embodiments, the electrode film comprises a blended cathode active material in an amount of, of about, of at least, or at least about, 70 wt. %, 75 wt. %, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. %, 100 wt. %, or any range of values therebetween.

In some embodiments, a second electrode film is an anode electrode film. In some embodiments, the anode electrode film includes an anode active material. In some embodiments, anode active materials can include, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si-SiOx, Sn-SnOx, Si-SiOx-C, Sn—SnOx-C, Si—Sn—C, SiOx-SnOx-C, Si—SiOx-Sn, or Sn-SiOx-SnOx). Anode active materials include common natural graphite, synthetic or artificial graphite, surface modified graphite, spherical-shaped graphite, flake-shaped graphite and blends or combinations of these types of graphite, metallic elements and its compound as well as metal-C composite for anode.

In some embodiments, an electrode film comprises a carbon material configured to reversibly intercalate lithium ions. In some embodiments, the electrode film comprises the carbon material in a total amount of, of about, of at most, or at most about, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, or any range of values therebetween. In some embodiments, the lithium intercalating carbon is selected from a graphitic carbon, graphite, hard carbon, soft carbon and combinations thereof. For example, the electrode film of the electrode can include a binder material, one or more of graphitic carbon, graphite, graphene-containing carbon, hard carbon and soft carbon, and an electrical conductivity promoting material. In some embodiments, an electrode is mixed with lithium metal and/or lithium ions.

In some embodiments, an electrode film includes a conductive additive. In some embodiments, the conductive additive may comprise a conductive carbon additive. In some embodiments, the conductive carbon additive comprises a carbon black, carbon nanotubes, such as single-walled carbon nanotubes (SWCNTs) and multi-walled carbon nanotubes (MWCNTs). In some embodiments, the electrode film comprises the conductive additive in a total amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, or any range of values therebetween. In some embodiments, each of the conductive additive is in an amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, of the electrode film, or any range of values therebetween. In some embodiments, the conductive additive is carbon black.

In some embodiments, the electrode film includes a binder. In some embodiments, binders can include polytetrafluoroethylene (PTFE), a polyolefin, polyalkylenes, polyethers, styrene-butadiene, co-polymers of polysiloxanes and polysiloxane, branched polyethers, polyvinylethers, a carboxymethylcellulose (CMC), co-polymers thereof, and/or combinations thereof. In some embodiments, the polyolefin can include polyethylene (PE), polypropylene (PP), polyvinylidene fluoride (PVDF), co-polymers thereof, and/or combinations thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or combinations thereof. In some embodiments, the binder may include a thermoplastic. In some embodiments, the binder comprises a fibrillizable and/or fibrillized polymer. In certain embodiments, the binder comprises, consists essentially, or consists of a single fibrillizable and/or fibrillized binder, such as PTFE. In some embodiments, the binder comprises, consists essentially, or consists of PVDF. In some embodiments, the electrode film comprises a binder in an amount of, of about, of at most, or at most about, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, or any range of values therebetween.

In some embodiments, the electrode film comprises a thickness of, of about, of at most, or at most about, 1000 μm, 900 μm, 800 μm, 700 μm, 600 μm, 500 μm, 400 μm, 300 μm, 250 μm, 200 μm, 150 μm, 100 μm, 90 μm, 80 μm, 70 μm, 60 μm, 50 μm, 40 μm, 30 μm, 20 μm, 15 μm, 10 μm, or any range of values there between. In some embodiments, the electrode film may provide an active material loading (which may be expressed as mass of electrode film per unit area of electrode film or current collector) of, of about, of at least, of at least about 3 mg/cm², 4 mg/cm², 5 mg/cm², 10 mg/cm², 15 mg/cm², 20 mg/cm², 30 mg/cm², 40 mg/cm², 50 mg/cm², 100 mg/cm², or any range of values therebetween.

An electrode film thickness can be selected to correspond to a desired areal capacity, specific capacity, areal energy density, energy density, or specific energy density. In some embodiments, the electrode film may provide an areal capacity (which may be expressed as capacity per unit area of electrode film or current collector) of, of about, of at least, of at least about 1 mAh/cm², 1.5 mAh/cm², 1.7 mAh/cm², 1.9 mAh/cm², 2.0 mAh/cm², 2.5 mAh/cm², 3 mAh/cm², 3.5 mAh/cm², 4 mAh/cm², 4.5 mAh/cm², 5 mAh/cm², 5.5 mAh/cm², 6 mAh/cm², 6.5 mAh/cm², 7 mAh/cm², 7.5 mAh/cm², 8 mAh/cm², 9 mAh/cm², 10 mAh/cm², 11 mAh/cm², 12 mAh/cm², 13 mAh/cm², 14 mAh/cm², 15 mAh/cm², 20 mAh/cm², 25 mAh/cm², or any range of values therebetween.

In some embodiments, an electrode film is disposed on a current collector. In some embodiments, a current collector can include a metallic material, such as a material comprising aluminum, nickel, copper, combinations of the foregoing. In some embodiments, a current collector comprises a pure metal. In some embodiments, a current collector comprises a metallized polymer film or metal coated polymer film. In some embodiments, the polymer comprises polyethylene terephthalate (PET), biaxially oriented polypropylene (BOPP) or a combination thereof. In some embodiments, the metal coating comprises aluminum. In some embodiments, coating the final electrode film mixture comprises forming a uniform electrode film mixture coating. In some embodiments, the current collector comprises a thickness of, of about, of at most, or at most about, 200 μm, 100 μm, 50 μm, 40 μm, 30 μm, 20 μm, 15 μm, 10 μm, 5 μm, or any range of values therebetween.

In some embodiments, the electrode film can be a wet processed electrode film. In some embodiments, the electrode film is prepared by a wet or slurry-based electrode fabrication process. In some embodiments, the electrode film of the present disclosure can be a dry processed electrode film. In some embodiments, the electrode film is prepared by a dry electrode fabrication process. As used herein, a dry electrode fabrication process can refer to a process in which no or substantially no solvents are used to form a dry electrode film. For example, components of the active layer or electrode film, including carbon materials and binders, may comprise, consist of, or consist essentially of dry particles. The dry particles for forming the active layer or electrode film may be combined to provide a dry particle active layer mixture. In some embodiments, the active layer or electrode film may be formed from the dry particle active layer mixture such that weight percentages of the components of the active layer or electrode film and weight percentages of the components of the dry particles active layer mixture are substantially the same. In some embodiments, the active layer or electrode film formed from the dry particle active layer mixture using the dry fabrication process may be free from, or substantially free from, any processing additives such as solvents and solvent residues resulting therefrom. In some embodiments, the resulting active layer or electrode films are self-supporting films formed using the dry process from the dry particle mixture. In some embodiments, the resulting active layer or electrode films are free-standing films formed using the dry process from the dry particle mixture. A process for forming an active layer or electrode film can include fibrillizing the fibrillizable binder component(s) such that the film comprises fibrillized binder. In further embodiments, a free-standing active layer or electrode film may be formed in the absence of a current collector. In still further embodiments, an active layer or electrode film may comprise a fibrillized polymer matrix such that the film is self-supporting. It is thought that a matrix, lattice, or web of fibrils can be formed to provide mechanical structure to the electrode film.

### Energy Storage Device

In some embodiments, an energy storage device comprises a separator, an anode electrode, a cathode electrode, an electrolyte, and a housing, wherein the electrolyte, separator, anode electrode and cathode electrode are disposed within the housing and the separator is positioned between the anode and cathode electrodes. In some embodiments, the cathode comprises the blended cathode active material described herein. In some embodiments, an energy storage device is formed by placing an electrolyte, a separator, an anode electrode, and the cathode electrode described herein within a housing, wherein the separator is placed between the anode electrode and the cathode electrode. In some embodiments the energy storage device is a battery. In some embodiments the energy storage device is a lithium-ion battery. In some embodiments, the energy storage device comprises an anode electrode positioned between two cathode electrodes.

In some embodiments, the energy storage device is charged with a suitable lithium-containing electrolyte. For example, the energy storage device can include a lithium salt, and a solvent, such as a non-aqueous or organic solvent. Generally, the lithium salt includes an anion that is redox stable. In some embodiments, the anion can be monovalent. In some embodiments, a lithium salt can be selected from lithium hexafluorophosphate (LiPF₆), lithium bis(trifluoromethanesulfonyl)imide (LiFSI), lithium tetrafluoroborate (LiBF₄), perchlorate (LiClO₄), lithium lithium bis(trifluoromethansulfonyl)imide (LiN(SO₂CF₃)₂), lithium trifluoromethansulfonate (LiSO₃CF₃), lithium bis(oxalate)borate (LiB(C₂O₄)₂), lithium bis(fluorosulfonyl)imide (LiN(SO₂F)₂, lithium difluoro (oxalate) borate (LiC₂BF₂O₄) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 2 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about 1.1 M, about 1.2 M, 1.3M, 1.4M, 1.5M or values therebetween.

In some embodiments, an energy storage device can include a liquid solvent. The solvent need not dissolve every component, and need not completely dissolve any component, of the electrolyte. In further embodiments, the solvent can be an organic solvent. In some embodiments, a solvent can include one or more functional groups selected from dioxathiolane (e.g., 1,3,2-dioxathiolane-2,2-dioxide (i.e., “DTD”)), carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In some embodiments, one or more solvents can be used at a concentration of, of about, of at least, or at least about, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. % or 90 wt. %, or any range of values therebetween. In some embodiments, solvents are utilized as additives in the electrolyte system, and can be used at a concentration of, of about, of at most, or at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 4 wt. %, 5 wt. %, 6 wt. %, 7 wt. %, 8 wt. %, 9 wt. % or 10 wt. %, or any range of values therebetween. For example, in some embodiments, the amount of an additive in the electrolyte is or is about in any one of the following ranges: 0.1-10 wt. %, 1-6 wt. %, 2-5 wt. %, 0.1-6 wt. %, 2-8 wt. %, 2-3 wt. %, or 1-4 wt. %.

In some embodiments, an energy storage device including a blended cathode active material may be characterized as having improved performances, such as improved electrode capacities, improved cell cycling performance, reduced loss of capacity over the life of the device, improved storage stability, improved power delivery, reduced electrode degradation and/or reduced capacity fade.

In some embodiments, the cathode of the energy storage device comprises an initial specific capacity of, of about, of at least, or of at least about, 100 mAh/g, 120 mAh/g, 140 mAh/g, 150 mAh/g, 160 mAh/g, 170 mAh/g, 180 mAh/g, 190 mAh/g, 200 mAh/g, 250 mAh/g, 300 mAh/g, or any range of values therebetween. In some embodiments, a capacity retention is, is about, is at least, or is at least about, 75%, 80%, 85% or 90% of original capacity after 2000 cycles, or any range of values therebetween. In some embodiments, capacity at a C-rate of 2 is, is about, is at least, or at least about 75%, 80%, 85% or 90% of capacity at a C-rate of 0.1, or any range of values therebetween. In some embodiments, a capacity retention is, is about, is at least, or is at least about, 80%, 85%, 90% or 95% of the original or fifth cycle capacity after cycling for 3000 hours, or any range of values therebetween. In some embodiments, a capacity retention is, is about, is at least, or is at least about, 90%, 91%, 92%, 93%, 94%, or 95% of the original or fifth cycle capacity after cycling for 7,000 hours, or any range of values therebetween. In some embodiments, a capacity retention is, is about, is at least, or is at least about, 90%, 95%, 96%, or 97% of the original or fifth cycle capacity after cycling for 4,500 hours, or any range of values therebetween. In some embodiments, the irreversible capacity loss is, is about, is at most, or is at most about, 8%, 7%, 6%, 5%, 4% or 3% after being stored for 500 hours, or any range of values therebetween. In some embodiments, the irreversible capacity loss is, is about, is at most, or is at most about, 3%, 2% or 1% after being stored for 1,000 hours, or any range of values therebetween.

In some embodiments, an energy storage device including a blended cathode active material reduces the degradation of iron into the electrolyte that may deposit on the anode. In some embodiments, the areal loading of iron deposited on anode electrodes after cycling for 7,000 hours at 40° C. is, is about, is at most, or is at most about, 0.8 μg/cm², 0.7 μg/cm², 0.6 μg/cm² or 0.5 μg/cm², or any range of values therebetween. In some embodiments, the areal loading of iron deposited on anode electrodes after 3,400 hours of cycling at 55° C. is, is about, is at most, or is at most about, 1.8 μg/cm², 1.6 μg/cm², 1.4 μg/cm², 1.2 μg/cm² or 1.1 μg/cm², or any range of values therebetween. In some embodiments, the areal loading of iron deposited on anode electrodes after 4,400 hours of cycling at 70° C. is, is about, is at most, or is at most about, 6 μg/cm², 5.5 μg/cm², 5 μg/cm², 4.5 μg/cm², 4 μg/cm², 3.5 μg/cm² or 3 μg/cm², or any range of values therebetween.

### EXAMPLES

Example embodiments of the present disclosure, including processes, materials and/or resultant products, are described in the following examples.

### Example 1-Processed and Treated Nickel Oxide Based Active Material Preparation

Unprocessed LiNi_{1-x-y} MnₓCo_{y}O₂ (NMC) powders were ball milled for about 5 days to form the processed NMC powders. A ceramic milling jar and zirconia milling beads were used to mill the unprocessed NMC powders. The milling jar was loaded with 1 kg of unprocessed NMC powders in a dry room and then sealed air-tight before milling. The milling was carried out on a roller mill apparatus in air.

The processed NMC powders were then heated in O₂ atmosphere for about 5 hours at 650° C., 700° C., and 800° C. respectively to form the treated NMC powders.

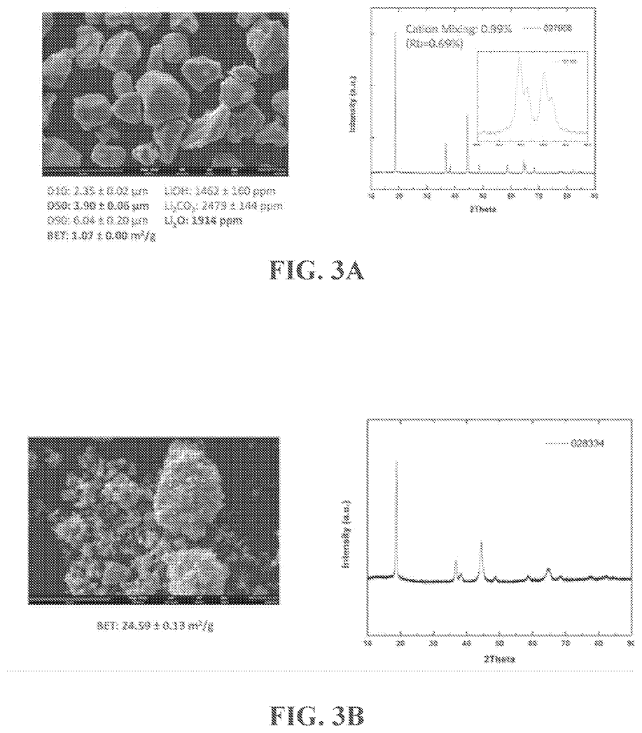

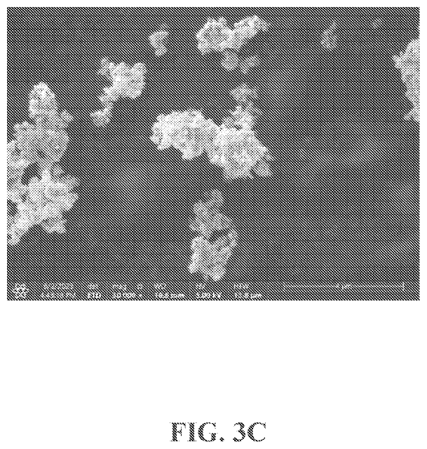

FIG. 3A illustrates the SEM image and XRD spectrum of the unprocessed NMC powders. As illustrated FIG. 3A, the unprocessed NMC has a relatively smooth surface. FIG. 3B illustrates the SEM image and XRD spectrum of the processed NMC powders. FIG. 3C illustrates the SEM image of the treated NMC powders heated at 700° C.

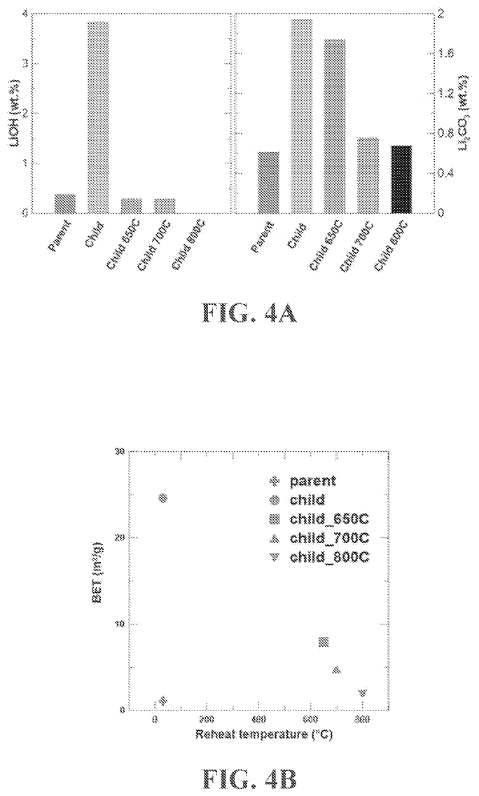

FIG. 4A illustrates the amount of impurities of the unprocessed and treated NMC powders formed at different conditions. As illustrated in FIG. 4A, the unprocessed NMC powders (“parent”) have a relatively low amount of LiOH and Li₂CO₃. In contrast, the amount of LiOH and Li₂CO₃ in the processed NMC powders (“child”) is relatively large. The amount of LiOH and Li₂CO₃ in the treated NMC powders after being heated at 650° C. (“child 650 C”), 700° C. (“child 700 C”), and 800° C. (“child 800 C”) are respectively increasingly reduced relative to the processed NMC powders without heating.

FIG. 4B illustrates the specific surface area of the unprocessed, processed and treated NMC powders formed at different conditions. As illustrated in FIG. 4B, the specific surface area of the unprocessed NMC powders (parent) is relatively low, the specific surface area of the processed NMC powders (“child”) is relatively high, and the specific surface area of the treated NMC powders heated at 650° C. (“child_650 C”), 700° C. (“child_700 C”), and 800° C. (“child_800 C”) respectfully increasingly decrease relative to the processed NMC powders without heating.

### Example 2-Blended Cathode Preparation

LiFePO₄ (LFP) and unprocessed or treated LiNi_{1-x-y} MnₓCo_{y}O₂ (NMC) powder were blended in a mass ratio of 9:1 or 9.8:0.2 to form a blended cathode active material mixture. The resulting LFP/NMC mixture, carbon black, polyvinylidene fluoride (PVDF) and N-methyl-2-pyrrolidone (NMP) were blended into a slurry. The mass ratio of LFP/NMC mixture:carbon black:PVDF was 96:2:2 or 92:4:4. A slurry coater was used to coat the resulting slurry on an aluminum foil. The coated electrode was then baked in a furnace at over 120° C. to remove all the NMP solvent.

### Example 3-LFP/Unprocessed NMC Pouch Cell Build

Three types of pouch cells were prepared with unprocessed NMC powders. Two kinds of NMCs were tested and blended with LFP in the cathodes: LiNi_{0.6}Mn_{0.4}O₂ (NMC640) and LiNi_{0.83}Mn_{0.06}Co_{0.11}O₂ (Ni83 or NMC Ni83). The mass ratio of LFP/NMC mixture:carbon black:PVDF was 96:2:2. All of the anodes in the cells were graphite. Table 1 summarizes the prepared LFP/NMC cell builds.

TABLE 1
Summary of LFP/NMC Cell Builds

| | LFP/Unprocessed | | LFP/Unprocessed | | LFP Cell | |
|---|---|---|---|---|---|---|
| | NMC640 Cell | | Ni83 Cell | | (Reference) | |
| Cathode (wt. %) | 90% LFP; | | 90% LFP; | | 100% LFP | |
| | 10% unprocessed | | 10% unprocessed | | | |
| | NMC640 | | NMC Ni83 | | | |
| Balanced Voltage | 3.8 | V | 3.8 | V | 3.8 | V |
| Capacity | 220 | mAh | 220 | mAh | 220 | mAh |
| Positive area | 85.5 | cm² | 85.5 | cm² | 85.5 | cm² |

| | | | |
|---|---|---|---|
| N/P ratio | 1.15 | 1.15 | 1.15 |

“Balanced Voltage” is a voltage where the cells were designed to have a ratio of areal capacities between cathode and anode equivalent to 115:100, which is the “N/P ratio, and a designed capacity of 220 mAh.
“Positive area” is the area of electrode coating on the positive side (cathode).

### Example 4-LFP/Unprocessed NMC Electrochemical Performance

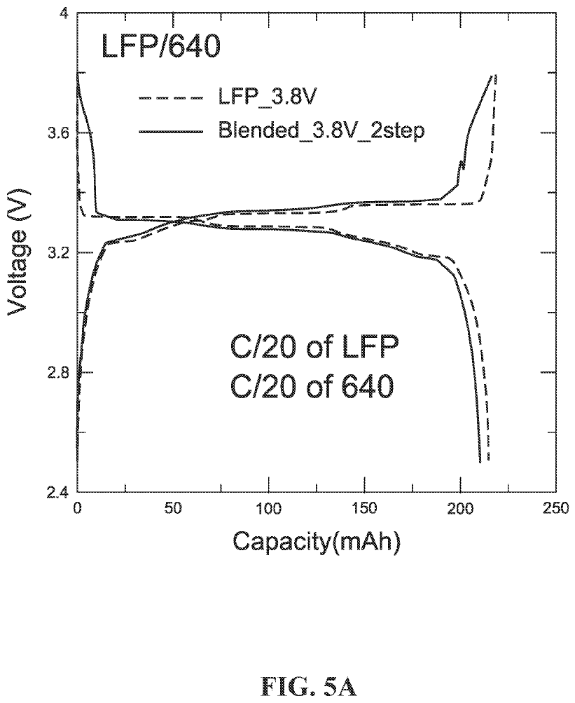

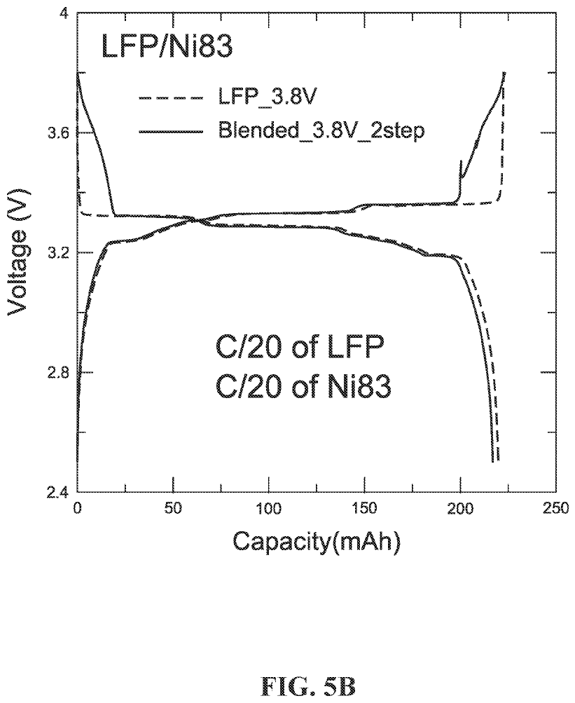

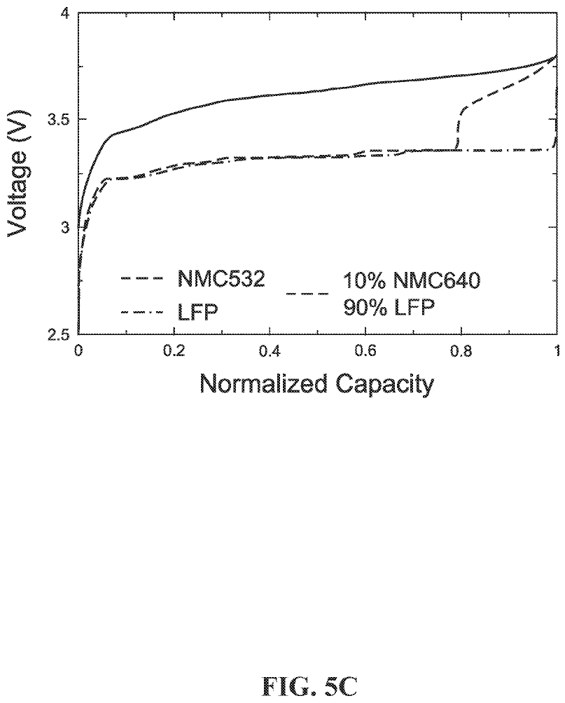

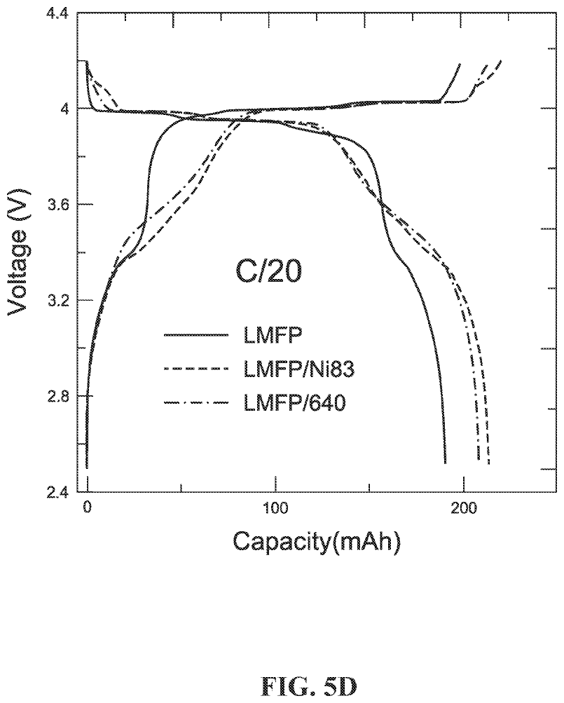

The electrochemical performance for the cells prepared in Example 3 were tested. FIG. 5A illustrates the first charge/discharge voltage-capacity curves of a cell containing a blended cathode active material including 90% LFP and 10% unprocessed NMC640, relative to a baseline cell including 100% LFP. FIG. 5B illustrates the first charge/discharge voltage-capacity curves of a cell containing a blended cathode active material including 90% LFP and 10% unprocessed NMC Ni83, relative to a baseline cell including 100% LFP.

As illustrated in FIGS. 5A and 5B, the LFP cells were constant-current charged to 3.8V and then constant-current discharged to 2.5V at C/20, where 5 C is equal to 220 mAh. All the capacity of LFP was stored between 2.5V-3.5V, as the cells did not significantly increase in capacity when charged to voltages greater than 3.5V.

The LFP/Unprocessed NMC640 cells and LFP/Unprocessed Ni83 cells were charged and discharged in a two-step procedure (also referred as “Blended_3.8V_2step”). The LFP/Unprocessed NMC640 cells and LFP/Unprocessed Ni83 cells were (1) constant-current then constant-voltage (CCCV) charged to 3.5V at C/3 (based on LFP capacity); (2) constant-current charged to 3.8 V at C/3 (based on NMC capacity); (3) constant-current discharged to 3.5 V at C/3 (based on NMC capacity); and (4) constant-current discharged to 2.5V at C/3 (based on LFP capacity). As such, in the blended cells, all the capacity between 2.5V-3.5V LFP was provided by the LFP, and all the capacity from 3.5V-3.8V was provided by the NMC, as illustrated as an extra slope in FIGS. 5A and 5B.

FIG. 5C illustrates the voltage vs. normalized charge capacity curve of the LFP/Unprocessed NMC640 cell, relative to a baseline cell including 100% LFP and another cell including 100% unprocessed NMC532. The cells were balanced for charging to 3.8 V, and the experiments were conducted at 70° C. at a cycling rate of C/3. The voltage-capacity profile of the LFP/Unprocessed NMC640 cell was distinguishable relative to the 100% LFP and 100% unprocessed NMC532 cells, as the materials were delithiated in entirely separately voltage ranges. In addition, it was observed that the addition of 10 wt. % unprocessed NMC640 in the LFP/Unprocessed NMC640 cell was responsible for approximately 20% of the capacity, when charging was limited to 3.8 V.

### Example 5-LMFP/Unprocessed NMC Pouch Cell Build

Three pouch cells were prepared, wherein two kinds of unprocessed NMCs were tested and blended with LiMn_{0.8}Fe_{0.2}PO₄ (LMFP) in the cathodes: LiNi_{0.6}Mn_{0.4}O₂ (NMC640) and LiNi_{0.83}Mn_{0.06}Co_{0.11}O₂ (Ni83 or NMC Ni83). All of the anodes in the cells were graphite. Table 2 summarizes the prepared LMFP/Unprocessed NMC cell builds.

TABLE 2
Summary of LMFP/Unprocessed NMC Cell Builds

| | LMFP/Unprocessed | LMFP/Unprocessed | LMFP Cell |
|---|---|---|---|
| | NMC640 Cell | Ni83 Cell | (Reference) |
| Cathode | 75% LMFP; | 75% LMFP; | 100% LMFP |
| (wt. %) | 25% unprocessed | 25% unprocessed | |
| | NMC640 | NMC Ni83 | |
| Balanced | 4.2 V | 4.2 V | 4.2 V |
| Voltage | | | |

### Example 6-LMFP/Unprocessed NMC Electrochemical Performance

The electrochemical performance for the cells prepared in Example 5 were tested. FIG. 5D illustrates the first charge/discharge voltage-capacity curves of a cell containing a blended cathode active material including LMFP/Unprocessed NMC640 and LMFP/Unprocessed Ni83, relative to a baseline cell including 100% LMFP.

Since the voltage ranges of LMFP and NMC overlap, a one-step charge/discharge procedure was utilized. As illustrated in FIG. 5D, all the cells were constant-current charged to 4.2V, followed by constant-current discharged to 2.5V at C/20, where 5 C is equal to 220 mAh. Similar to FIGS. 5A and 5B, extra slopes observed in the LMFP/Unprocessed NMC640 and LMFP/Unprocessed Ni83 cells relative to LMFP cells.

### Example 7-LFP/Unprocessed NMC640 Cycling Performance at 40° C.

The cycling performance for LFP/Unprocessed NMC640 cells (i.e., “Blended” or “Blended cell”) were tested at 40° C., relative to a baseline cell including 100% LFP (i.e., “LFP” or “LFP cell”). The cells included electrolytes with 1.5M lithium bis(fluorosulfonyl)imide (LiFSI) salt, dissolved in an ethylene carbonate (EC) and dimethyl carbonate (DMC) solvent (volume ratio of EC:DMC was 3:7) with 2 wt. % of vinylene carbonate (VC) as an additive. The testing procedures for LFP/Unprocessed NMC640 and LFP cells were as follows:
(a) “LFP_3.5V”-LFP cell (1) CCCV charged to 3.5 V at C/3; and (2) constant-current discharged to 2.5 V at C/3;
(b) “Blended_3.5V_no_acti”-Blended cell (1) CCCV charged to 3.5 V at C/3; and (2) constant-current discharged to 2.5 V at C/3;
(c) “Blended_3.5V_one_acti”-Blended cell; First cycle: (1) CCCV charged to 3.8 V at C/3; and (2) constant-current discharged to 2.5 V at C/3; Rest of cycles: (1) CCCV charged to 3.5 V at C/3; and (2) constant-current discharged to 2.5 V at C/3;
(d) “Blended_9_3.5V_1_3.8V”-Blended cell; 1. (1) CCCV charged to 3.5 V at C/3; and (2) constant-current discharged to 2.5 V at C/3 for 9 cycles; 2. CCCV charged to 3.5 V at C/3; (2) constant-current charged to 3.8 V at C/3; (3) constant-current discharged to 3.5 V at C/3; (4) constant-current discharged to 2.5V at C/3 for 1 cycles; and 3. Loop back to Step 1;
(e) “LFP_3.8V”-LFP cell (1) CCCV charged to 3.8 V at C/3; and (2) constant-current discharged to 2.5 V at C/3;
(f) “Blended_3.8V_1step”-Blended cell (1) CCCV charged to 3.8 V at C/3; and (2) constant-current discharged to 2.5 V at C/3;
(g) “Blended_3.8V_2step”-Blended cell (1) CCCV charged to 3.5 V at C/3; (2) constant-current charge to 3.8 V at C/3; (3) constant-current discharged to 3.5 V at C/3; and (4) constant-current discharged to 2.5 V at C/3; and
(h) “Blended_3.7V_2step”-Blended cell (1) CCCV charged to 3.5V at C/3 (based on LFP capacity); (2) constant-current charged to 3.7 V at C/3; (3) constant-current discharged to 3.5 V at C/3; and (4) constant-current discharged to 2.5 V at C/3.

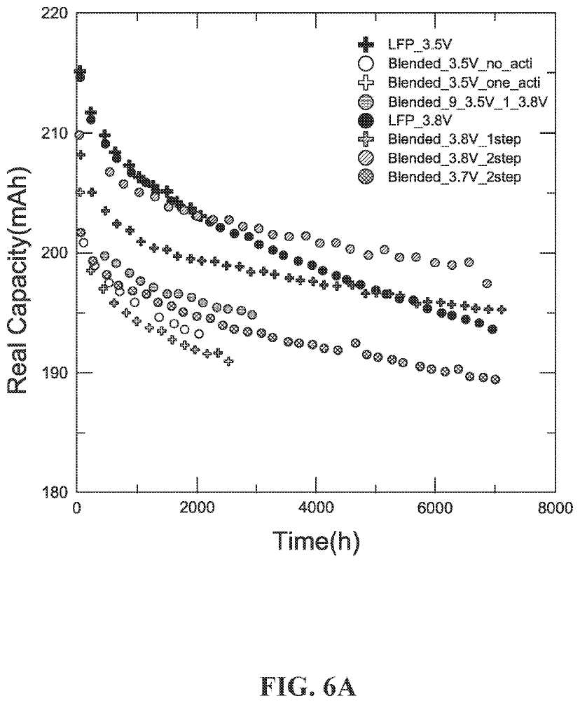

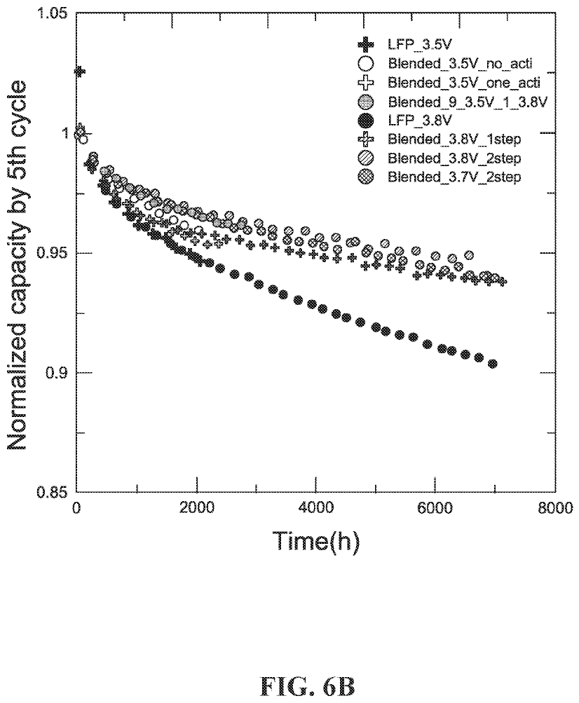

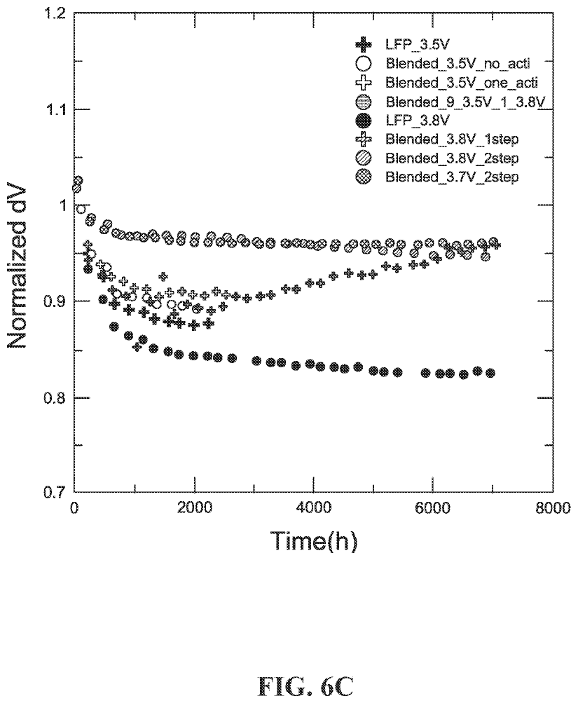

FIG. 6A shows the real cell discharge capacity vs. cycling time of the LFP/Unprocessed NMC640 and LFP cells described, and FIG. 6B shows the cell discharge capacities of FIG. 6A normalized to the fifth cycle. FIGS. 6A and 6B demonstrate that LFP/Unprocessed NMC640 cells improved the overall capacity retention by a factor of two, relative to the baseline cell including 100% LFP. FIGS. 6A and 6B also show improved NMC capacity activation, as LFP/Unprocessed NMC640 cells provided superior overall capacity retention.

FIG. 6C shows internal resistance (via normalized delta V (dV)) vs. cycling time of the LFP/Unprocessed NMC640 and LFP cells described. Delta V is the difference between average charge voltage and average discharge voltage, representing the cell's impendence evolution over cycling time. The blended and pure LFP cells were observed to have stable cell impendences throughout cycling. It was further observed that blending NMC with LFP did not result in impendence growth during cycling at 40° C.

### Example 8-LFP/Unprocessed NMC640 Cycling Performance at 55° C.

The cycling performance for LFP/Unprocessed NMC640 cells (i.e., “Blended” or “Blended cell”) were tested at 55° C., relative to a baseline cell including 100% LFP (i.e., “LFP” or “LFP cell”). The cells contained the same electrolytes as Example 7. The testing procedures for LFP/Unprocessed NMC640 and LFP cells were as follows:
(a) “LFP_3.5V”-LFP cell (1) CCCV charged to 3.5 V at C/3; and (2) constant-current discharged to 2.5 V at C/3;
(b) “LFP_3.8V”-LFP cell (1) CCCV charged to 3.8 V at C/3; and (2) constant-current discharged to 2.5 V at C/3;
(c) “Blended_3.5V_one_acti”-Blended cell; First cycle: (1) CCCV charged to 3.8 V at C/3; and (2) constant-current discharged to 2.5 V at C/3; Rest of cycles: (1) CCCV charged to 3.5 V at C/3; and (2) constant-current discharged to 2.5 V at C/3; and
(d) “Blended_3.8V_2step”-Blended cell (1) CCCV charged to 3.5 V at C/3; (2) constant-current charge to 3.8 V at C/3; (3) constant-current discharged to 3.5 V at C/3; and (4) constant-current discharged to 2.5 V at C/3.

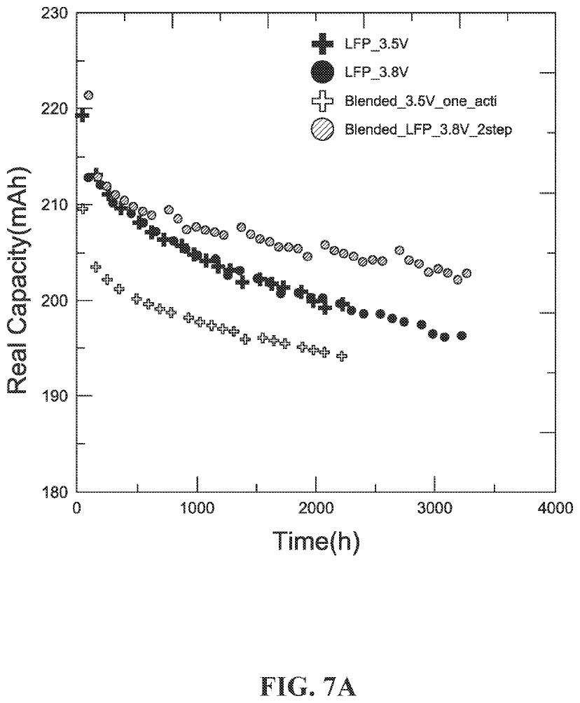

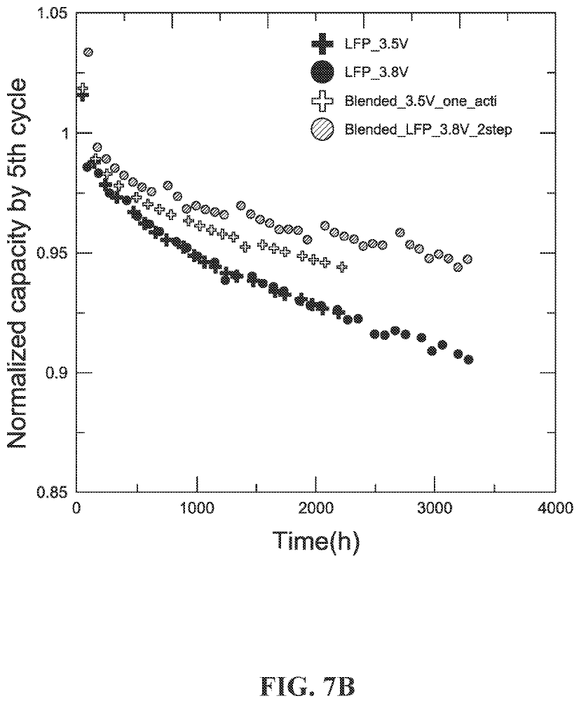

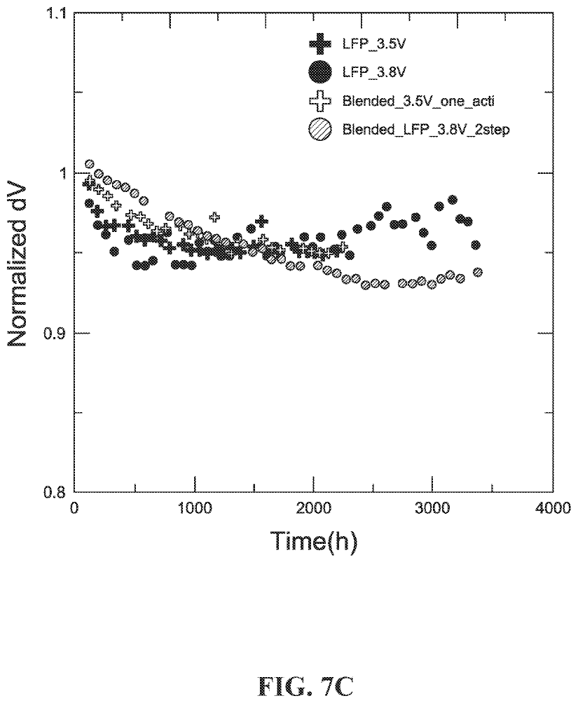

FIG. 7A shows the real cell discharge capacity vs. cycling time of the LFP/Unprocessed NMC640 and LFP cells described, and FIG. 7B shows the cell discharge capacities of FIG. 7A normalized to the fifth cycle. FIGS. 7A and 7B demonstrate the same improvement of capacity retention in blended LFP/Unprocessed NMC640 cells comparing to the LFP cells, at 55° C. FIG. 7C shows internal resistance (via normalized delta V (dV)) vs. cycling time of the LFP/Unprocessed NMC640 and LFP cells described, and demonstrate that blending NMC with LFP did not result in impendence growth during cycling at 55° C.

### Example 9-LFP/Unprocessed NMC640 Cycling Performance at 70° C.

The cycling performance for LFP/Unprocessed NMC640 cells (i.e., “Blended” or “Blended cell”) were tested at 70° C., relative to a baseline cell including 100% LFP (i.e., “LFP” or “LFP cell”). The cells contained the same electrolytes as Example 7. The testing procedures for LFP/Unprocessed NMC640 and LFP cells were as follows:
(a) “LFP_3.5V”-LFP cell (1) CCCV charged to 3.5 V at C/3; and (2) constant-current discharged to 2.5 V at C/3;
(b) “Blended_3.5V_no_acti”-Blended cell (1) CCCV charged to 3.5 V at C/3; and (2) constant-current discharged to 2.5 V at C/3;
(c) “Blended_3.5V_one_acti”-Blended cell; First cycle: (1) CCCV charged to 3.8 V at C/3; and (2) constant-current discharged to 2.5 V at C/3; Rest of cycles: (1) CCCV charged to 3.5 V at C/3; and (2) constant-current discharged to 2.5 V at C/3;
(d) “Blended_9_3.5V_1_3.8V”-Blended cell; 1. (1) CCCV charged to 3.5 V at C/3; and (2) constant-current discharged to 2.5 V at C/3 for 9 cycles; 2. CCCV charged to 3.5 V at C/3; (2) constant-current charged to 3.8 V at C/3; (3) constant-current discharged to 3.5 V at C/3; (4) constant-current discharged to 2.5V at C/3 for 1 cycles; and 3. Loop back to Step 1;
(e) “LFP_3.8V”-LFP cell (1) CCCV charged to 3.8 V at C/3; and (2) constant-current discharged to 2.5 V at C/3;
(f) “Blended_3.8V_1step”-Blended cell (1) CCCV charged to 3.8 V at C/3; and (2) constant-current discharged to 2.5 V at C/3;
(g) “Blended_3.8V_2step”-Blended cell (1) CCCV charged to 3.5 V at C/3; (2) constant-current charge to 3.8 V at C/3; (3) constant-current discharged to 3.5 V at C/3; and (4) constant-current discharged to 2.5 V at C/3); and
(h) “Blended_3.7V_2step”-Blended cell (1) CCCV charged to 3.5V at C/3; (2) constant-current charged to 3.7 V at C/3; (3) constant-current discharged to 3.5 V at C/3; and (4) constant-current discharged to 2.5 V at C/3.

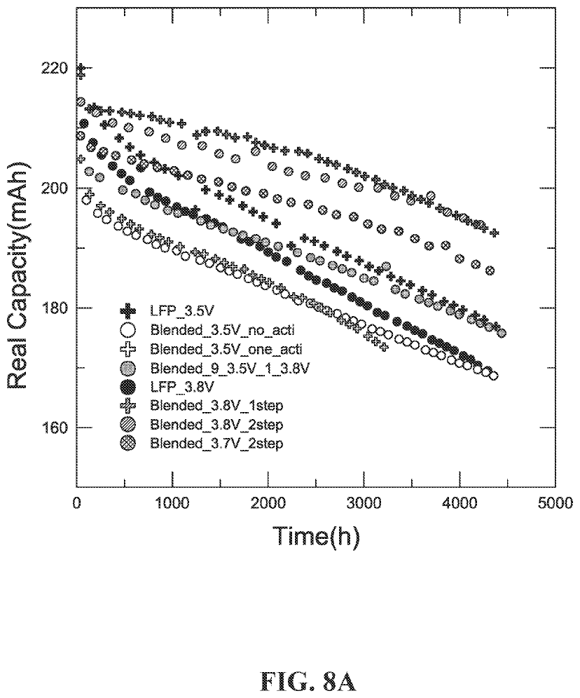

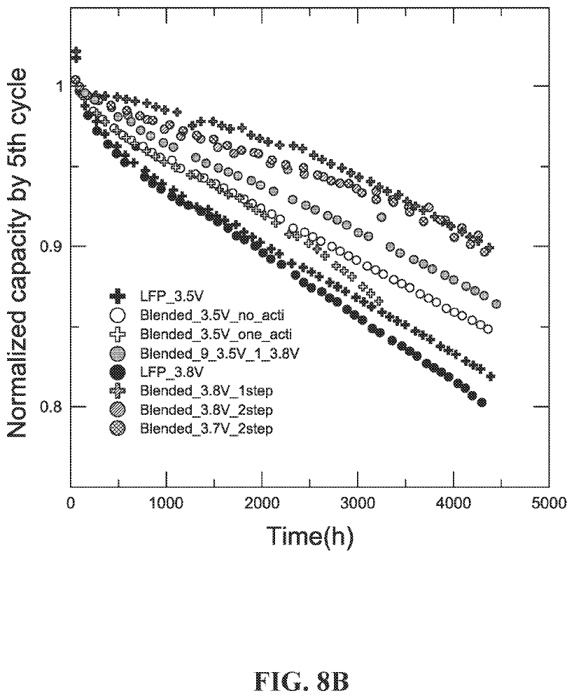

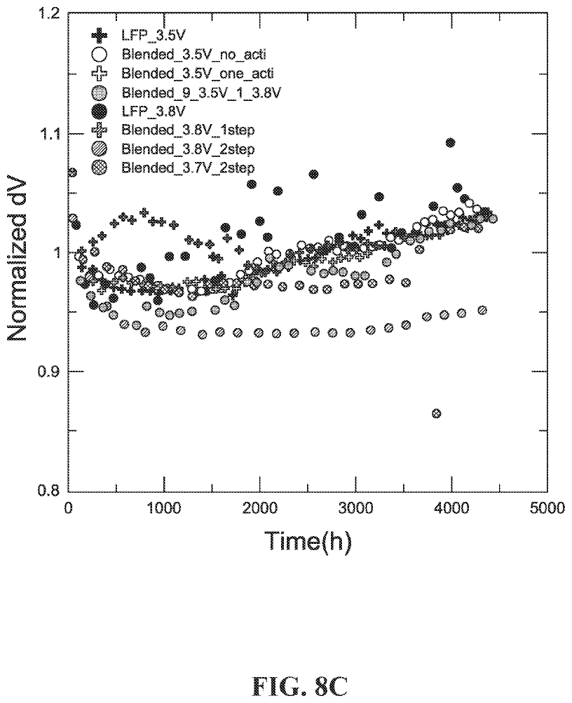

FIG. 8A shows the real cell discharge capacity vs. cycling time of the LFP/Unprocessed NMC640 and LFP cells described, and FIG. 8B shows the cell discharge capacities normalized to the fifth cycle. FIGS. 8A and 8B show that LFP/Unprocessed NMC640 cells demonstrate improved overall capacity retention at higher voltages. FIG. 8C shows internal resistance (via normalized delta V (dV)) vs. cycling time of the LFP/Unprocessed NMC640 and LFP cells described, and demonstrates that blending NMC with LFP did not result in impendence growth during cycling at 70° C.

### Example 10-LFP/Unprocessed NMC640 Full Cycling Performance at 70° C.

The full electrochemical cycling performance for LFP/Unprocessed NMC640 cells (i.e., “Blended,” “Blended cell” or “NMC+LFP”) were tested at 70° C., relative to a baseline cell including 100% LFP (i.e., “LFP” or “LFP cell”) or 100% NMC532 (i.e., “NMC” or “NMC cell”). The cell type, electrolyte salt, and testing procedures for LFP/Unprocessed NMC640, NMC and LFP cells were as follows:
(a) “NMC w/LiPF₆ (3.80V)”-NMC532 cell including electrolytes with lithium hexafluorophosphate (LiPF₆) salt, dissolved in a 3:7 blended solvent ratio of EC and DMC with 2 wt. % VC, charged to 3.8 V at C/3;
(b) “NMC w/LiFSI (3.80V)”-NMC532 cell including electrolytes with LiFSI salt, dissolved in a 3:7 blended solvent ratio of EC and DMC with 2 wt. % VC, charged to 3.8 V at C/3;
(c) “LFP w/LiPF₆ (3.65V)”-LFP cell including electrolytes with LiPF₆ salt, dissolved in a 3:7 blended solvent ratio of EC and DMC with 2 wt. % VC, charged to 3.65 V at C/3;
(d) “LFP w/LiFSI (3.65V)”-LFP cell including electrolytes with LiFSI salt, dissolved in a 3:7 blended solvent ratio of EC and DMC with 2 wt. % VC, charged to 3.65 V at C/3;
(e) “NMC+LFP w/LiPF₆ (3.80V)”-LFP/NMC640 cell including electrolytes with LiPF₆ salt, dissolved in a 3:7 blended solvent ratio of EC and DMC with 2 wt. % VC, charged to 3.8 V at C/3; and
(f) “NMC+LFP w/LiFSI (3.80V)”-LFP/NMC640 cell including electrolytes with LiFSI salt, dissolved in a 3:7 blended solvent ratio of EC and DMC with 2 wt. % VC, charged to 3.8 V at C/3.

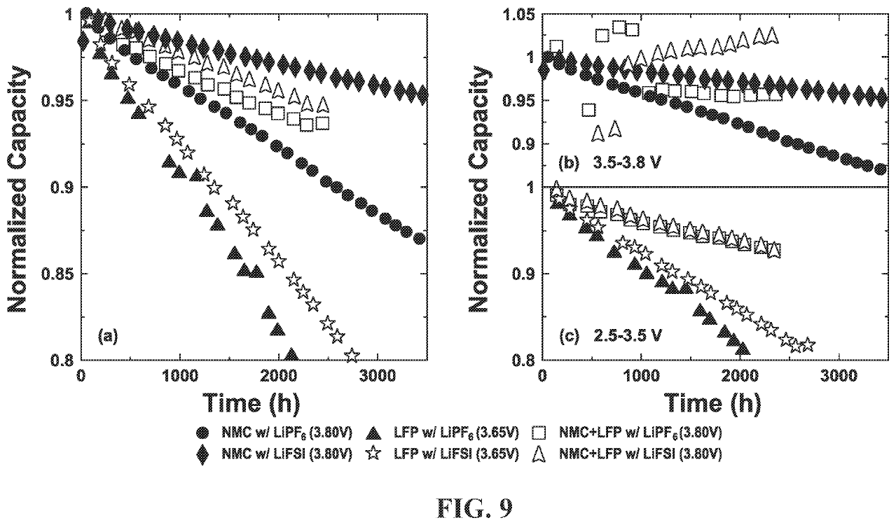

Plot (a) of FIG. 9 shows the discharge capacity as a function of time for the full electrochemical cycling window of the LFP/Unprocessed NMC640, LFP and NMC cells described. The LFP cells showed the fastest rate of capacity loss, followed by the NMC532 cell that contained LiPF₆. The LFP/Unprocessed NMC640 cell containing LiPF₆ showed improved capacity retention relative to the NMC532 cell. Surprisingly, LFP/Unprocessed NMC640 cells, which comprised a positive electrode predominantly of LFP, provided superior capacity retention relative to cells with an NMC positive electrode, at 70° C. using an LiPF₆ electrolyte. Moreover, LFP/Unprocessed NMC640 cells containing LiFSI electrolytes showed improved capacity retention relative to LFP/Unprocessed NMC640 cells containing LiPF₆ electrolytes.

Plot (b) and (c) of FIG. 9 show the discharge capacity sorted by the contributions above 3.5 V (i.e., 3.5-3.8V) and below 3.5 V (i.e., 2.5-3.5V), respectively, wherein discharge capacity above 3.5 V may be indicative of capacity attributed to NMC and below 3.5 V is indicative of capacity attributed to LFP. As observed in plot (b) of FIG. 9, LFP/Unprocessed NMC640 cells showed very low rates of capacity fade after 1,000 hours. Moreover, plot (c) of FIG. 9 shows that the inclusion of unprocessed NMC640 in the blended positive electrode cells resulted in improved reversible cycling with decreased fractional fade compared to LFP cells. The LFP/Unprocessed NMC640 cells also shows excellent performance when LiPF₆ was used. Accordingly, as observed in FIG. 9, the inclusion of NMC in LFP cells provided enhanced cycle life.

### Example 11-LFP/Unprocessed Ni83 Cycling Performance at 70° C.

The cycling performance for LFP/Unprocessed Ni83 cells (i.e., “Blended” or “Blended cell”) were tested at 70° C., relative to a baseline cell including 100% LFP (i.e., “LFP” or “LFP cell”). The cells included electrolytes with 1.5M LiFSI salt, dissolved in a 3:7 blended solvent ratio of EC and DMC with 2 wt. % VC. The testing procedures for LFP/Ni83 and LFP cells were as follows:
(a) “LFP_3.5V”-LFP cell (1) CCCV charged to 3.5 V at C/3; and (2) constant-current discharged to 2.5 V at C/3;
(b) “Blended_3.5V_no_acti”-Blended cell (1) CCCV charged to 3.5 V at C/3; and (2) constant-current discharged to 2.5 V at C/3;
(c) “Blended_3.5V_one_acti”-Blended cell; First cycle: (1) CCCV charged to 3.8 V at C/3; and (2) constant-current discharged to 2.5 V at C/3; Rest of cycles: (1) CCCV charged to 3.5 V at C/3; and (2) constant-current discharged to 2.5 V at C/3;
(d) “LFP_3.8V”-LFP cell (1) CCCV charged to 3.8 V at C/3; and (2) constant-current discharged to 2.5 V at C/3;
(e) “Blended_3.8V_1step”-Blended cell (1) CCCV charged to 3.8 V at C/3; and (2) constant-current discharged to 2.5 V at C/3; and
(f) “Blended_3.8V_2step”-Blended cell (1) CCCV charged to 3.5 V at C/3; (2) constant-current charge to 3.8 V at C/3; (3) constant-current discharged to 3.5 V at C/3; and (4) constant-current discharged to 2.5 V at C/3.

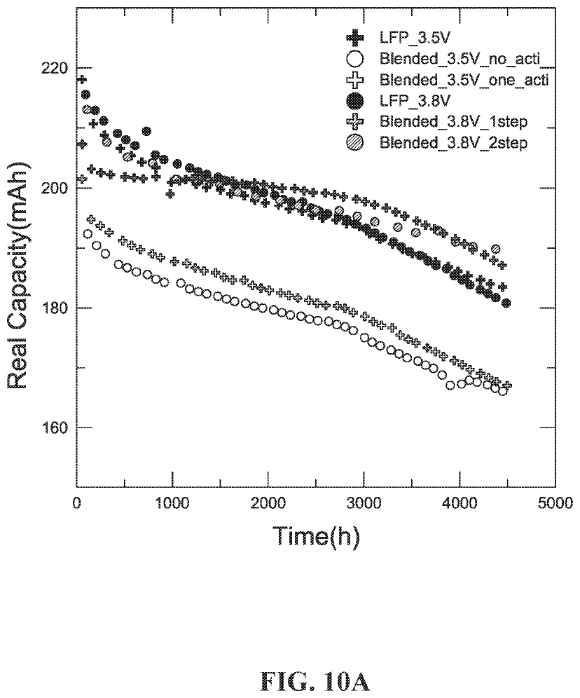

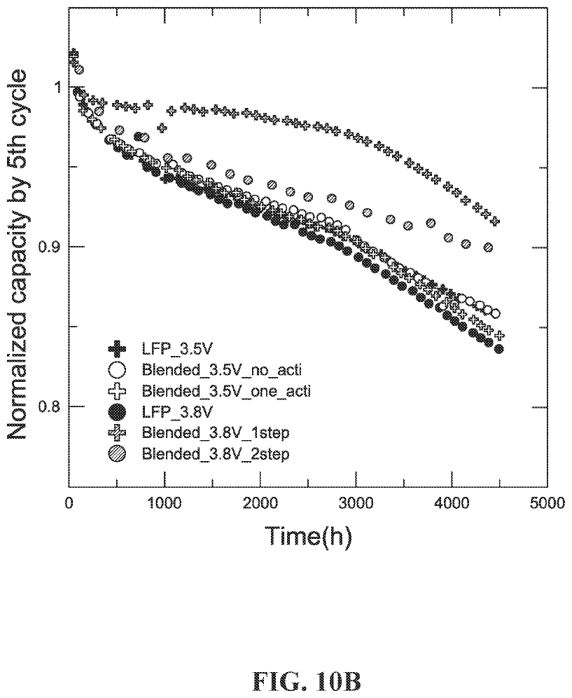

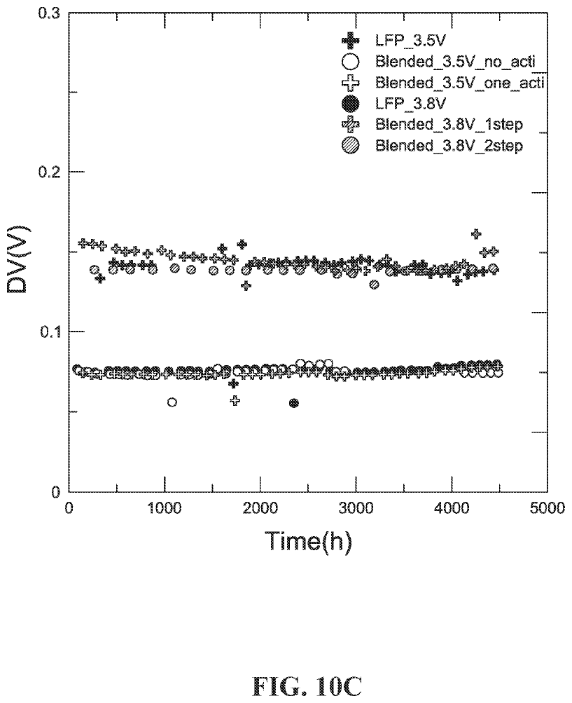

FIG. 10A shows the real cell discharge capacity vs. cycling time of the LFP/Unprocessed Ni83 and LFP cells described herein, and FIG. 10B shows the cell discharge capacities normalized to the fifth cycle. FIGS. 10A and 10B demonstrate that blending LFP with 10% Ni83 improved the overall capacity retention of the cells. FIG. 10C shows internal resistance (via normalized delta V (dV)) vs. cycling time of the LFP/Unprocessed Ni83 and LFP cells, and demonstrate that blending NMC with LFP did not result in impendence growth during cycling at 70° C.

### Example 12-LMFP/Unprocessed NMC640 and LMFP/Unprocessed Ni83 Cycling Performances

The cycling performances for LMFP/Unprocessed NMC640 cells and LMFP/Unprocessed Ni83 cells were tested at 40° C., 55° C. and 70° C. relative to a baseline cell including 100% LMFP (i.e., “LMFP” or “LMFP cell”). The cells included electrolytes with 1.5M LiPF₆ salt, dissolved in a 3:7 blended solvent ratio of EC and DMC with 2 wt. % VC and 1 wt. % 1,3,2-dioxathiolane-2,2-dioxide (DTD). The LMFP/Unprocessed NMC640, LMFP/Unprocessed Ni83 and LMFP cells were CCCV charged and constant-current discharged in a voltage range from 4.2 V to 2.5 V at a rate of C/3.

The LMFP/Unprocessed NMC640 and LMFP/Unprocessed Ni83 cells provided similar cycling performances relative to the baseline 100% LMFP cells.

### Example 13-Anode Iron Deposition

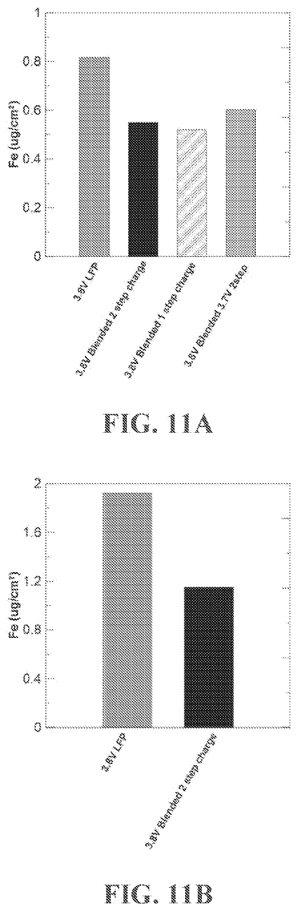

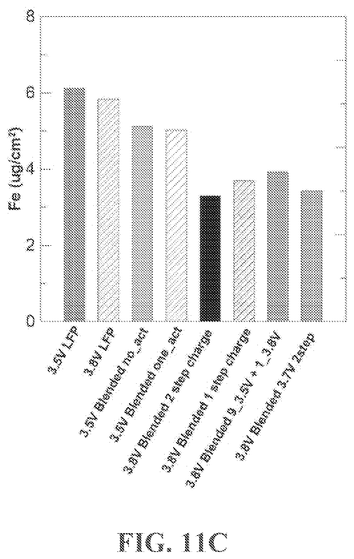

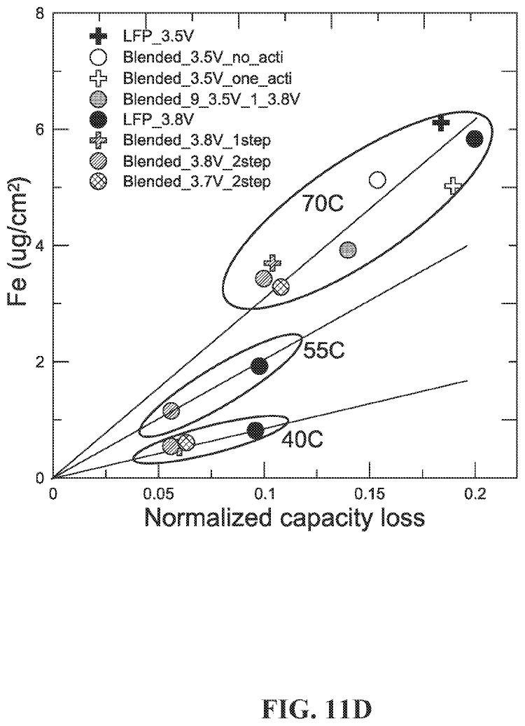

In order to verify whether Fe dissolution from LFP is reduced by blending NMC with LFP, X-ray fluorescence (XRF) spectroscopy was utilized to quantify the areal loading (μg/cm²) of Fe deposited on the graphite anode in LFP/Unprocessed NMC640 cells and pure LFP cells. FIG. 11A is a bar chart showing the areal loading of iron deposited on anode electrodes after 7,000 hours of cycling at 40° C. For example, FIG. 11A shows that the amount of iron deposition on anode electrodes in pure LFP cells was about 0.8 μg/cm² after 7,000 hours of cycling at 40° C., while the amount of iron deposition on anode electrodes in LFP/Unprocessed NMC640 cells was about 0.6 μg/cm² or less. FIG. 11B is a bar chart showing the areal loading of iron deposited on anode electrodes after 3,400 hours of cycling at 55° C. For example, FIG. 11B shows that the amount of iron deposition on anode electrodes in pure LFP cells was about 1.9 μg/cm² after 3,400 hours of cycling at 55° C., while the amount of iron deposition on anode electrodes in LFP/Unprocessed NMC640 cells was less than about 1.2 μg/cm². FIG. 11C is a bar chart showing the areal loading of iron deposited on anode electrodes after 4,400 hours of cycling at 70° C. For example, FIG. 11C shows that the amount of iron deposition on anode electrodes in pure LFP cells was about 6 μg/cm² after 4,400 hours of cycling at 70° C., while the amount of iron deposition on anode electrodes in LFP/Unprocessed NMC640 cells was at most about 5 μg/cm² and as low as about 3.5 μg/cm². As demonstrated in FIGS. 11A, 11B, and 11C, cells including LFP/Unprocessed NMC640 showed less Fe dissolution from the cathode and deposition onto anodes than baseline cells including 100% LFP.

FIG. 11D is a plot showing the areal loading of iron deposited on anode electrodes for cells after being held at different temperatures, as a function of normalized discharge capacity loss. In other words, FIG. 11D shows the normalized discharge capacity loss in these long-cycled cells vs. the areal loading (μg/cm²) of Fe on their graphite anodes. At each temperature, LFP/Unprocessed NMC640 cells cycled up to 3.8 V provided the least amount of Fe deposition and least capacity loss. Furthermore, cells with 100% LFP provided the most Fe deposition and most capacity loss. In addition, the normalized capacity loss and the areal loading of Fe shows a linear correlation at each temperature, indicating that cell capacity loss and Fe dissolution from the cathode electrode are positively correlated and can be reduced by blending unprocessed NMC with LFP.

### Example 14-LFP/Unprocessed NMC640 Cell Storage Test at 60° C.

Electrochemical impedance spectroscopy (EIS) was utilized to measure charge transfer resistance (Rct) for cells comprising various cathode active material, after being stored for 500 hours and 1,000 hours. By comparing Rct before and after the storage, the increase in the cell's resistance to charge transfer can be determined during the course of the storage. Here, LFP/Unprocessed NMC640 cells and pure LFP cells were filled with electrolytes that contained either 1.5M LiFSI salt or 1.5M LiPF₆ salt, dissolved in a 3:7 blended solvent ratio of EC and DMC with 2 wt. % VC. The cells were charged to 3.8 V at C/20 and then stored under open circuit conditions at 60° C., without being charged or discharged by an external circuit. The cells' capacity loss and impedance were measured after 500 hours and 1,000 hours.

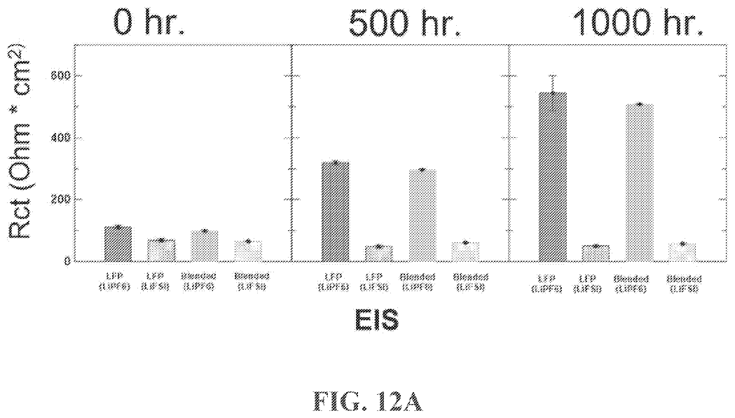

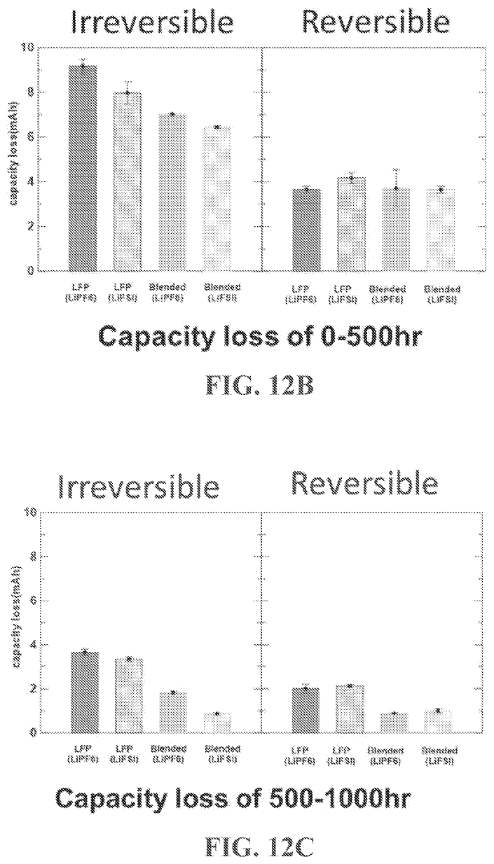

FIG. 12A are bar charts showing the area specific charge transfer resistance for cells comprising various cathode active materials and electrolyte salts, relative to a baseline cell, after being stored at 60° C. As demonstrated by FIG. 12A, cells with LiPF₆ salts had much larger Rct growth. However, when utilizing the same electrolyte solutions, LFP/Unprocessed NMC640 cells showed similar Rct as pure LFP cells.

FIGS. 12B and 12C show the capacity loss during the storage period at 60° C. Irreversible loss refers to the portion of capacity loss that cannot be recovered in the following cycle. Reversible loss refers to the portion of capacity loss that can be recovered in the following cycle. In both 0-500 hour and 500-1,000 hour storages at 60° C., the LFP/Unprocessed NMC640 cells showed lower irreversible loss than pure LFP cells. In addition, the reversible loss of the LFP/NMC640 cells were similar to that of the pure LFP cells.

### Example 15-NMC622 Half-Cell Fabrication and Cycling Performance

Half cells were fabricated with the cathode electrodes including unprocessed, processed or treated NMC622 powders as the cathode active material. The unprocessed, processed or treated NMC622 powders, carbon black, and PVDF were mixed at a ratio of 92:4:4 in NMP to form a slurry. A slurry coater was used to coat the resulting slurry on aluminum foil. The coated electrode was then baked in a furnace at over 120° C. to remove NMP solvent to form a cathode. The formed cathode was fabricated in a half-cell. The half cells included electrolytes with 1M LiPF₆ salt, dissolved in an fluoroethylene carbonate (FEC) and dimethyl carbonate (DMC) solvent (volume ratio of FEC:DMC was 1:4).

The half cells were fabricated by placing the cathode electrode, a separator and a lithium foil within the half-cell housing. The half-cell cycling performance for the NMC622 cells were tested at 30° C. The testing procedures for NMC622 half cells were as follows: CCCV charged to 4.3V at C/5; and constant-current discharged to 3 V at C/5.

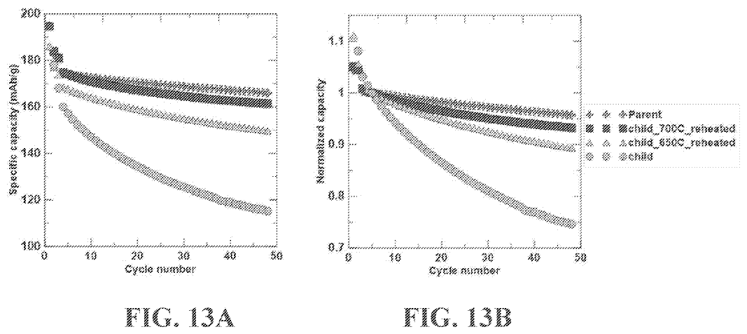

FIG. 13A shows the cycling performance of the NMC622 half cells with unprocessed NMC622 powders (“parent”), processed NMC622 powders (“child”), treated NMC622 powders heated at 650° C. (“child_650_reheated”), and treated NMC622 powders heated at 700° C. (“child_700_reheated”). FIG. 13B shows the normalized cycling performance of the NMC622 half cells. As illustrated in FIG. 13A, all the half cells have a similar initial capacity. As illustrated in FIGS. 13A and 13B, the half cells with unprocessed NMC622 powders and treated NMC622 powders heated at 650° C. and 700° C. have capacity retentions above 90% after 50 cycles, and the capacity retention of the treated NMC622 powders heated at 700° C. is similar to that of the unprocessed NMC622 powders.

### Example 16-LFP/NMC622 Cycling Performance at 55° C.

Three single layer pouch (SLP) cells were prepared with unprocessed or treated NMC powders similar to those of Example 3. LiNi_{0.6}Mn_{0.2}Co_{0.202} (NMC 622) NMC 622 was used. The unprocessed NMC622 powders were milled for about 5 days and then heated at 700° C. to form the treated NMC powders. The unprocessed or treated NMC powders were mixture with LFP in an intended ratio to form an LFP/NMC mixture. The mass ratio of LFP/NMC mixture:carbon black:PVDF was 92:4:4. All of the anodes in the cells were graphite. Table 3 summarizes the prepared LFP/NMC cell builds.

TABLE 3
Summary of LFP/NMC 622 Cell Builds

| | | | | | LFP/Treated | | | |
|---|---|---|---|---|---|---|---|---|
| | LFP/Unprocessed | | LFP/Unprocessed | | NMC Cell | | | |
| | NMC Cell | | NMC Cell | | (“SLP_2% | | LFP Cell | |
| | (“SLP_10% | | (“SLP_2%_{—} | | reheated_{—} | | (“SLP_LFP_{—} | |
| | parent_3.8 V”) | | parent_3.8 V”) | | child_3.8 V”) | | 3.8 V”) | |
| Cathode (wt. %) | 90% LFP; | | 98% LFP; | | 98% LFP; | | 100% LFP | |
| | 10% Unprocessed | | 2% Unprocessed | | 2% Treated NMC | | | |
| | NMC | | NMC | | | | | |
| Balanced Voltage | 3.8 | V | 3.8 | V | 3.8 | V | 3.8 | V |
| Cathode Capacity | 2.47 | mAh/cm² | 2.56 | mAh/cm² | 2.67 | mAh/cm² | 2.52 | mAh/cm² |
| Loading | | | | | | | | |
| Anode Capacity | 3 | mAh/cm² | 3 | mAh/cm² | 3 | mAh/cm² | 3 | mAh/cm² |
| Loading | | | | | | | | |

The cells were tested at 55° C. The cells contained the same electrolytes as those of Example 7. The testing procedures for LFP/NMC622 and LFP cells were as follows: CCCV charged to 3.8 V at C/3; and (2) constant-current discharged to 2.5 V at C/3.

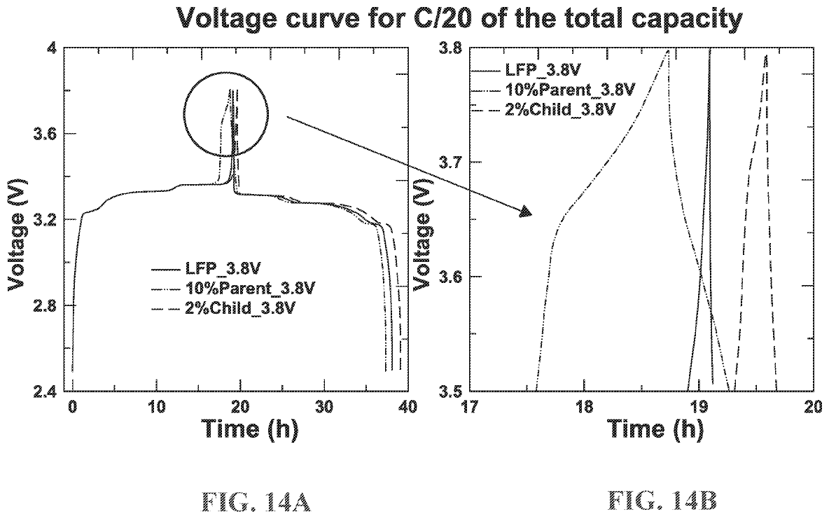

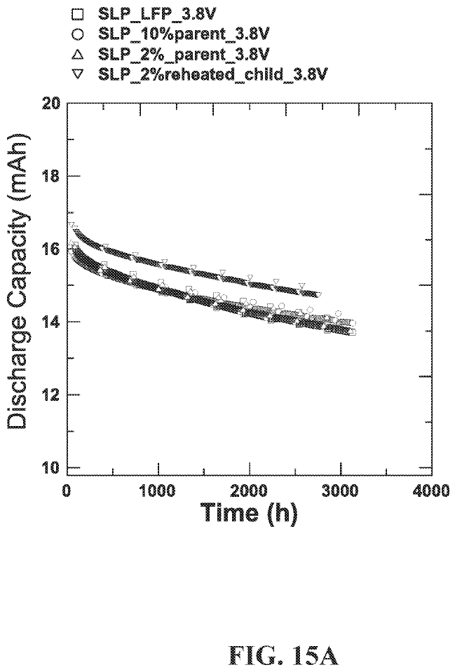

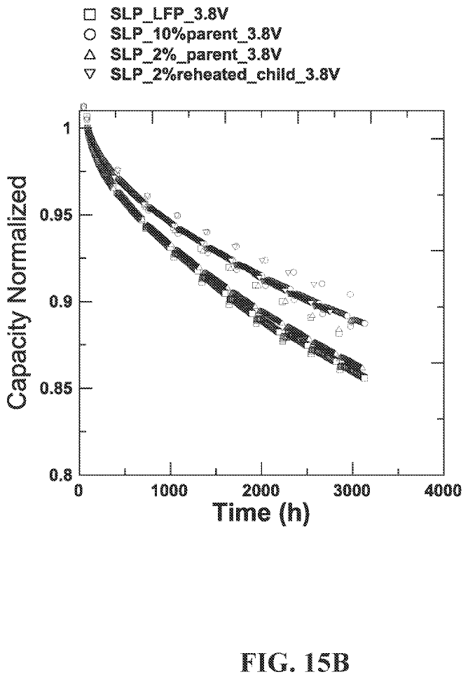

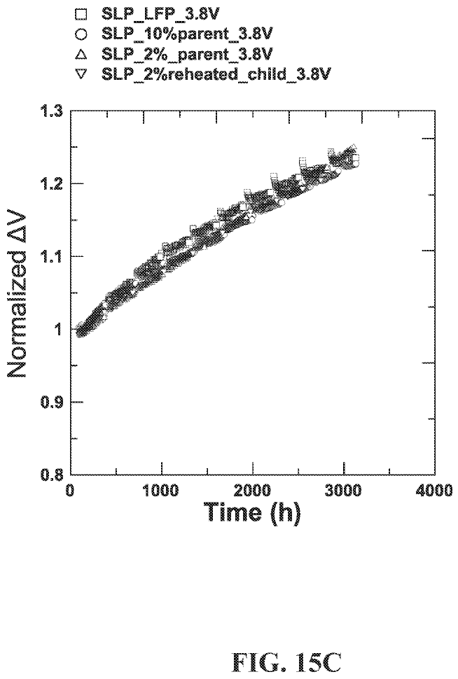

FIG. 14A shows a voltage v. time curve at C/20 of the total capacity. FIG. 14B is an enlarged figure showing the voltage curve in the circled area in FIG. 14A. FIG. 15A shows the real cell discharge capacity vs. cycling time plot of the LFP/NMC622 and LFP cells described, and FIG. 15B shows the normalized discharge capacities of FIG. 15A. FIGS. 15A and 15B demonstrate that the cell using 2 wt. % treated NMC 622 powders have similar performance and capacity retention as the cell using 10 wt. % unprocessed NMC622 powders, and improved capacity retention relative to the cell using 2 wt. % unprocessed NMC622 powders. In addition, all the cells using NMC622 powders blended with LFP powders have improved capacity retention relative to the cells using only LFP powders. FIG. 15C shows internal resistance (via normalized delta V (dV)) vs. cycling time of the LFP/NMC622 and LFP cells described.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

1. A blended cathode active material, comprising:
an iron phosphate based active material; and
a nickel oxide based active material comprising at least one lithium nickel manganese cobalt oxide or lithium nickel cobalt aluminum oxide.

2. The blended cathode active material of claim 1, wherein the iron phosphate based active material is selected from the group consisting of lithium iron phosphate (LFP), lithium manganese iron phosphate (LMFP), and combinations thereof.

3. The blended cathode active material of claim 1, wherein the nickel oxide based active material is selected from the group consisting of lithium nickel manganese cobalt oxide (NMC), lithium nickel cobalt aluminum oxide (NCA), and combinations thereof.

4. The blended cathode active material of claim 3, wherein the NMC is selected from the group consisting of NMC550, NMC640, NMC631, NMC730, NMC75:25:0, NMC532, NMC111, NMC811, NMC622, NMC Ni83, NMC Ni91, and combinations thereof.

5. The blended cathode active material of claim 1, wherein the blended cathode active material comprises the iron phosphate based active material at a concentration of about 90-99 wt. %.

6. The blended cathode active material of claim 1, wherein the blended cathode active material comprises the nickel oxide based active material at a concentration of about 0.1-15 wt. %.

7. The blended cathode active material of claim 1, wherein the blended cathode active material comprises the nickel oxide based active material at a concentration of about 0.1-3 wt. %.

8. The blended cathode active material of claim 1, wherein the nickel oxide based active material comprises a specific surface area of at least about 4 m²/g.

9. The blended cathode active material of claim 1, wherein the nickel oxide based active material comprises a lithium-containing impurity of less than about 3 wt. %.

10. The blended cathode active material of claim 9, wherein the lithium-containing impurity is selected from the group consisting of LiOH, Li₂CO₃, and combinations thereof.

11. The blended cathode active material of claim 1, wherein the nickel oxide based active material comprises LiOH in an amount of less than about 0.5 wt. %.

12. The blended cathode active material of claim 1, wherein the nickel oxide based active material comprises Li₂CO₃ in an amount of less than about 1 wt. %.

13. An energy storage device, comprising:
a cathode electrode comprising the blended cathode active material of claim 1;
a separator;
an anode electrode;
an electrolyte; and
a housing, wherein the cathode electrode, the separator, and the anode electrode are positioned within the housing.

14. The energy storage device of claim 13, wherein the anode electrode comprises a graphite active material.

15. A process of forming a blended cathode active material, comprising:
combining an iron phosphate based active material and a nickel oxide based active material to form a blended cathode active material mixture,
wherein the nickel oxide based active material comprises at least one of a lithium nickel manganese cobalt oxide and a lithium nickel cobalt aluminum oxide.

16. The process of claim 15, further comprising surface area processing the nickel oxide based active material prior to the combining.

17. The process of claim 15, wherein surface area processing the nickel oxide based active material comprises milling.

18. The process of claim 16, wherein surface area processing the nickel oxide based active material is performed in an atmosphere absent water and CO₂.

19. The process of claim 16, wherein surface area processing the nickel oxide based active material is performed in ambient air.

20. The process of claim 15, further comprising heating the nickel oxide based active material prior to combining the iron phosphate based active material and the nickel oxide based active material.

21. The process of claim 20, wherein heating is performed at a temperature between 650° C. and 800° C.

22. A method of forming a blended cathode active material, comprising:
surface area processing a nickel oxide based active material to form a processed nickel oxide based active material;
heating the processed nickel oxide based active material at a temperature between 650° C. and 800° C. to form a treated nickel oxide based active material; and
combining an iron phosphate based active material and the treated nickel oxide based active material to form a blended cathode active material mixture.

23. The method of claim 22, wherein the nickel oxide based active material comprises at least one of a lithium nickel manganese cobalt oxide and a lithium nickel cobalt aluminum oxide.

24. The method of claim 22, wherein a specific surface area of the treated nickel oxide based active material is larger than a specific surface area of the nickel oxide based active material.

25. The method of claim 22, wherein the blended cathode active material mixture comprises the treated nickel oxide based active material in an amount of about 0.1-3 wt. %.
